(19) United States
(12) Patent Application Publication
(10) Pub. No.: US 2015/0253546 A1
(43) Pub. Date: Sep. 10, 2015

(54) IMAGING LENS AND IMAGING APPARATUS EQUIPPED WITH THE IMAGING LENS

(71) Applicant: FUJIFILM Corporation, Tokyo (JP)

(72) Inventor: Ping SUN, Saitama-ken (JP)

(73) Assignee: FUJIFILM Corporation, Tokyo (JP)

(21) Appl. No.: 14/637,423

(22) Filed: Mar. 4, 2015

(30) Foreign Application Priority Data
Mar. 10, 2014 (JP) 046421/2014

(51) Int. Cl. G02B 13/00; G02B 9/62

(52) U.S. Cl. CPC G02B 13/0045; G02B 9/62

(57) ABSTRACT

An imaging lens is constituted essentially by six lenses, including: a first lens having a positive refractive power and a convex surface toward the object side; a second lens having a negative refractive power and a concave surface toward the object side; a third lens having a positive refractive power; a fourth lens having a negative refractive power; a fifth lens having a positive refractive power; and a sixth lens having a negative refractive power, provided in this order from the object side. The imaging lens satisfies a predetermined conditional formula.

### CROSS REFERENCE TO RELATED APPLICATIONS

The present application claims priority under 35 U.S.C. §119 to Japanese Patent Application No. 2014-046421 filed on Mar. 10, 2014. The above application is hereby expressly incorporated by reference, in its entirety, into the present application.

### BACKGROUND OF THE INVENTION

1. Technical Field

The present invention is related to a fixed focus imaging lens for forming optical images of subjects onto an imaging element such as a CCD (Charge Coupled Device) and a CMOS (Complementary Metal Oxide Semiconductor). The present invention is also related to an imaging apparatus provided with the imaging lens that performs photography such as a digital still camera, a cellular telephone with a built in camera, a PDA (Personal Digital Assistant), a smart phone, a tablet type terminal, and a portable gaming device.

2. Background Art

Accompanying the recent spread of personal computers in households, digital still cameras capable of inputting image data such as photographed scenes and portraits into personal computers are rapidly becoming available. In addition, many cellular telephones, smart phones, and tablet type terminals are being equipped with camera modules for inputting images. Imaging elements such as CCD's and CMOS's are employed in these devices having photography functions. Recently, miniaturization of these imaging elements is advancing, and there is demand for miniaturization of the entirety of the photography devices as well as imaging lenses to be mounted thereon. At the same time, the number of pixels in imaging elements is increasing, and there is demand for high resolution and high performance of imaging lenses. Performance corresponding to 5 megapixels or greater, and more preferably 8 megapixels or greater, is desired.

In response to such demands, imaging lenses having a five lens configuration, which is a comparatively large number of lenses, and imaging lenses having a six lens configuration, which has a greater number of lenses in order to improve performance further, have been proposed. For example, U.S. Patent Application Publication No. 20130235473, Taiwanese Patent Publication No. 201331623, Taiwanese Patent Publication No. 201326883, U. S. Patent Application Publication No. 20130003193, Taiwanese Patent Publication No. 201305596, U.S. Patent Application Publication No. 20120314301, and U.S. Patent Application Publication No. 20130070346 propose imaging lenses having six lens configurations.

### DISCLOSURE OF THE INVENTION

Meanwhile, there is demand for imaging lenses having comparatively short total lengths for use in apparatuses such as smart phones and tablet terminals to have wider angles of view in addition to shorter total lengths.

However, the total lengths of the imaging lenses disclosed in U.S. Patent Application Publication No. 20130235473, Taiwanese Patent Publication No. 201331623, Taiwanese Patent Publication No. 201326883, U.S. Patent Application Publication No. 20130003193, Taiwanese Patent Publication No. 201305596, U.S. Patent Application Publication No. 20120314301, and U.S. Patent Application Publication No. 20130070346 are too long to meet all of these demands. In addition, the angles of view of the imaging lenses disclosed in Taiwanese Patent Publication No. 201331623, U.S. Patent Application Publication No. 20130003193, U.S. Patent Application Publication No. 20120314301, and U.S. Patent Application Publication No. 20130070346 are too small. Therefore, it is difficult for the imaging lenses disclosed in U.S. Patent Application Publication No. 20130235473, Taiwanese Patent Publication No. 201331623, Taiwanese Patent Publication No. 201326883, U.S. Patent Application Publication No. 20130003193, Taiwanese Patent Publication No. 201305596, U. S. Patent Application Publication No. 20120314301, and U.S. Patent Application Publication No. 20130070346 to meet all of the above demands.

The present invention has been developed in view of the foregoing points. The object of the present invention is to provide an imaging lens that can realize a shortening of the total length while achieving a wide angle of view, is compatible with imaging elements that satisfy demand for a greater number of pixels, and can realize high imaging performance from a central angle of view to peripheral angles of view. It is another object of the present invention to provide an imaging apparatus equipped with the lens, which is capable of obtaining high resolution photographed images.

A first imaging lens of the present invention consists essentially of six lenses, including:

a first lens having a positive refractive power and a convex surface toward the object side;

a second lens having a negative refractive power and a concave surface toward the object side;

a third lens having a positive refractive power;

a fourth lens having a negative refractive power;

a fifth lens having a positive refractive power; and

a sixth lens having a negative refractive power, provided in this order from the object side;

the imaging lens satisfying the following conditional formula:

2.4<f3/f1<4.6 (1)

wherein f1 is the focal length of the first lens, and f3 is the focal length of the third lens.

A second imaging lens of the present invention consists essentially of six lenses, including:

a first lens having a positive refractive power and a convex surface toward the object side;

a second lens of a biconcave shape;

a third lens having a positive refractive power;

a fourth lens having a negative refractive power;

a fifth lens having a positive refractive power and a concave surface toward the object side; and

a sixth lens having a negative refractive power and a concave surface toward the object side, provided in this order from the object side.

Note that in the first and second imaging lenses of the present invention, the expression “consists essentially of six lenses” means that the imaging lens of the present invention may also include lenses that practically have no power, optical elements other than lenses such as a stop and a cover glass, and mechanical components such as lens flanges, a lens barrel, a camera shake correcting mechanism, etc., in addition to the six lenses. In addition, the shapes of the surfaces of the lenses and the signs of the refractive indices thereof are considered in the paraxial region in the case that the lenses include aspherical surfaces.

The optical performance of the first and second imaging lenses of the present invention can be further improved by adopting the following favorable configurations.

In the first imaging lens of the present invention, it is preferable for the fifth lens to have a concave surface toward the object side.

In the first imaging lens of the present invention, it is preferable for the sixth lens to have a concave surface toward the object side.

It is preferable for the first and second imaging lenses of the present invention to further comprise an aperture stop positioned at the object side of the surface of the second lens toward the object side.

The first imaging lens of the present invention may satisfy one or arbitrary combinations of Conditional Formulae (1-1) and (1-2), Conditional Formulae (2) and (2-1), Conditional Formulae (3) through (3-2), Conditional Formulae (4) and (4-1), Conditional Formulae (5) through (5-2), and Conditional Formula (6) below. The second imaging lens of the present invention may satisfy one or arbitrary combinations of Conditional Formulae (1) through (1-2), Conditional Formulae (2) and (2-1), Conditional Formulae (3) through (3-2), Conditional Formulae (4) and (4-1), Conditional Formulae (5) through (5-2), and Conditional Formula (6) below.

2.4<f3/f1<4.6 (1)

2.8<f3/f1<4.5 (1-1)

3<f3/f1<4.4 (1-2)

−2.1<f1/f6<−1.54 (2)

−2<f1/f6<−1.55 (2-1)

2.9<f34/f<8 (3)

2.95<f34/f<7.1 (3-1)

3<f34/f<6.5 (3-2)

0.85<(L1r+L1f)/(L1r−L1f)<1.16 (4)

0.87<(L1r+L1f)/(L1r−L1f)<1.15 (4-1)

−2.4<(L5r+L5f)/(L5r−L5f)<−0.9 (5)

−2.2<(L5r+L5f)/(L5r−L5f)<−0.95 (5-1)

−2.1<(L5r+L5f)/(L5r−L5f)<−1 (5-2)

0.5<f·tan ω/L6r<20 (6)

wherein f is the focal distance of the entire system, f1 is the focal length of the first lens, f3 is the focal length of the third lens, f6 is the focal length of the sixth lens, f34 is the combined focal length of the third lens and the fourth lens, L1r is the paraxial radius of curvature of the surface of the first lens toward the image side, L1f is the paraxial radius of curvature of the surface of the first lens toward the object side, L5r is the paraxial radius of curvature of the surface of the fifth lens toward the image side, L5f is the paraxial radius of curvature of the surface of the fifth lens toward the object side, L6r is the paraxial radius of curvature of the surface of the sixth lens toward the image side, and ω is half the maximum angle of view when focused on an object at infinity.

An imaging apparatus of the present invention is equipped with the imaging lens of the present invention.

According to the first and second imaging lenses of the present invention, the configuration of each lens element is optimized within a lens configuration having six lenses as a whole. Therefore, a lens system that can achieve a short total length, a wide angle of view, which is compatible with an increased number of pixels of imaging elements, and has high imaging performance from a central angle of view to peripheral angles of view can be realized.

The imaging apparatus of the present invention outputs image signals corresponding to optical images formed by the first or second imaging lens of the present invention. Therefore, the imaging apparatus of the present invention is capable of obtaining high resolution photographed images.

### BRIEF DESCRIPTION OF THE DRAWINGS

FIG. 1 is a sectional diagram that illustrates a first example of the configuration of an imaging lens according to an embodiment of the present invention, and corresponds to a lens of Example 1.

FIG. 2 is a sectional diagram that illustrates a second example of the configuration of an imaging lens according to an embodiment of the present invention, and corresponds to a lens of Example 2.

FIG. 3 is a sectional diagram that illustrates a third example of the configuration of an imaging lens according to an embodiment of the present invention, and corresponds to a lens of Example 3.

FIG. 4 is a sectional diagram that illustrates a fourth example of the configuration of an imaging lens according to an embodiment of the present invention, and corresponds to a lens of Example 4.

FIG. 5 is a sectional diagram that illustrates a fifth example of the configuration of an imaging lens according to an embodiment of the present invention, and corresponds to a lens of Example 5.

FIG. 6 is a sectional diagram that illustrates a sixth example of the configuration of an imaging lens according to an embodiment of the present invention, and corresponds to a lens of Example 6.

FIG. 7 is a diagram that illustrates the paths of light rays that pass through the imaging lens of FIG. 1.

FIG. 8 is a collection of diagrams that illustrate aberrations of the imaging lens of Example 1, wherein the diagrams illustrate spherical aberration, astigmatism, distortion, and lateral chromatic aberration, in this order from the left side of the drawing sheet.

FIG. 9 is a collection of diagrams that illustrate aberrations of the imaging lens of Example 2, wherein the diagrams illustrate spherical aberration, astigmatism, distortion, and lateral chromatic aberration, in this order from the left side of the drawing sheet.

FIG. 10 is a collection of diagrams that illustrate aberrations of the imaging lens of Example 3, wherein the diagrams illustrate spherical aberration, astigmatism, distortion, and lateral chromatic aberration, in this order from the left side of the drawing sheet.

FIG. 11 is a collection of diagrams that illustrate aberrations of the imaging lens of Example 4, wherein the diagrams illustrate spherical aberration, astigmatism, distortion, and lateral chromatic aberration, in this order from the left side of the drawing sheet.

FIG. 12 is a collection of diagrams that illustrate aberrations of the imaging lens of Example 5, wherein the diagrams illustrate spherical aberration, astigmatism, distortion, and lateral chromatic aberration, in this order from the left side of the drawing sheet.

FIG. 13 is a collection of diagrams that illustrate aberrations of the imaging lens of Example 6, wherein the diagrams illustrate spherical aberration, astigmatism, distortion, and lateral chromatic aberration, in this order from the left side of the drawing sheet.

FIG. 14 is a diagram that illustrates a cellular telephone as an imaging apparatus equipped with the imaging lens of the present invention.

FIG. 15 is a diagram that illustrates a smart phone as an imaging apparatus equipped with the imaging lens of the present invention.

### BEST MODE FOR CARRYING OUT THE INVENTION

Hereinafter, embodiments of the present invention will be described in detail with reference to the attached drawings.

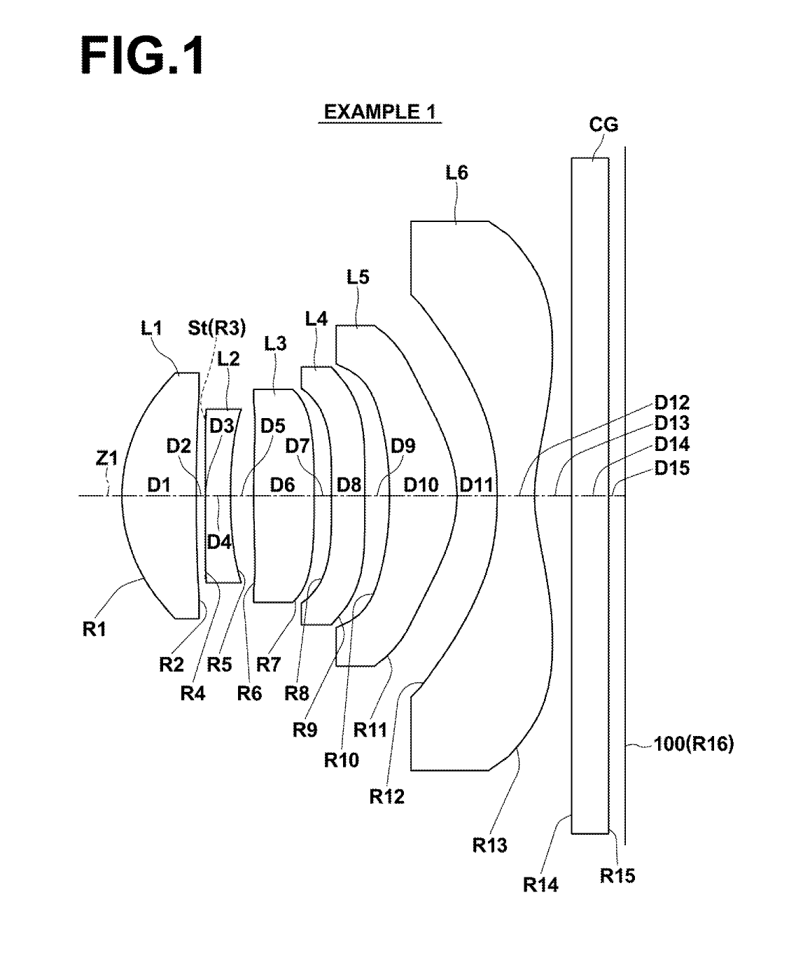

FIG. 1 illustrates a first example of the configuration of an imaging lens according to an embodiment of the present invention. This example corresponds to the lens configuration of Numerical Example 1 (Table 1 and Table 2), to be described later.

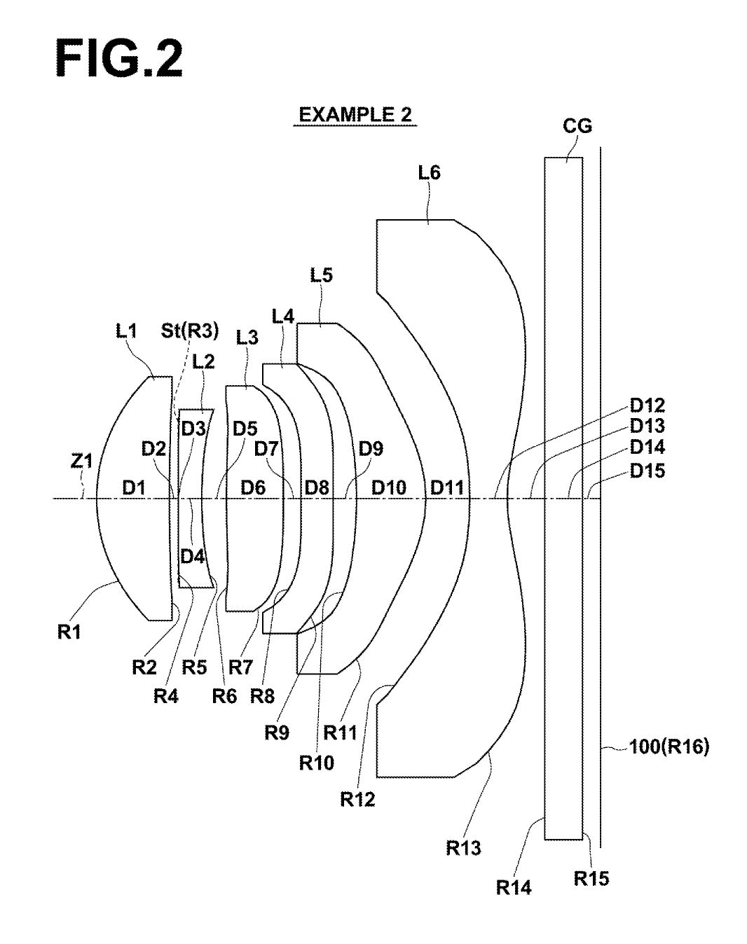

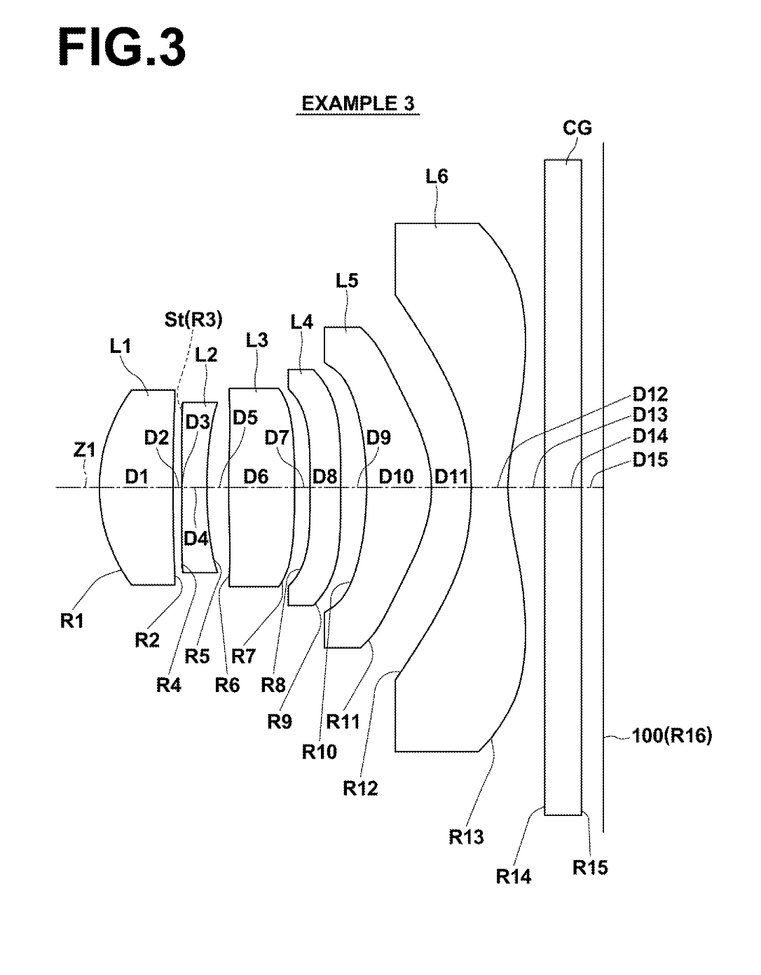

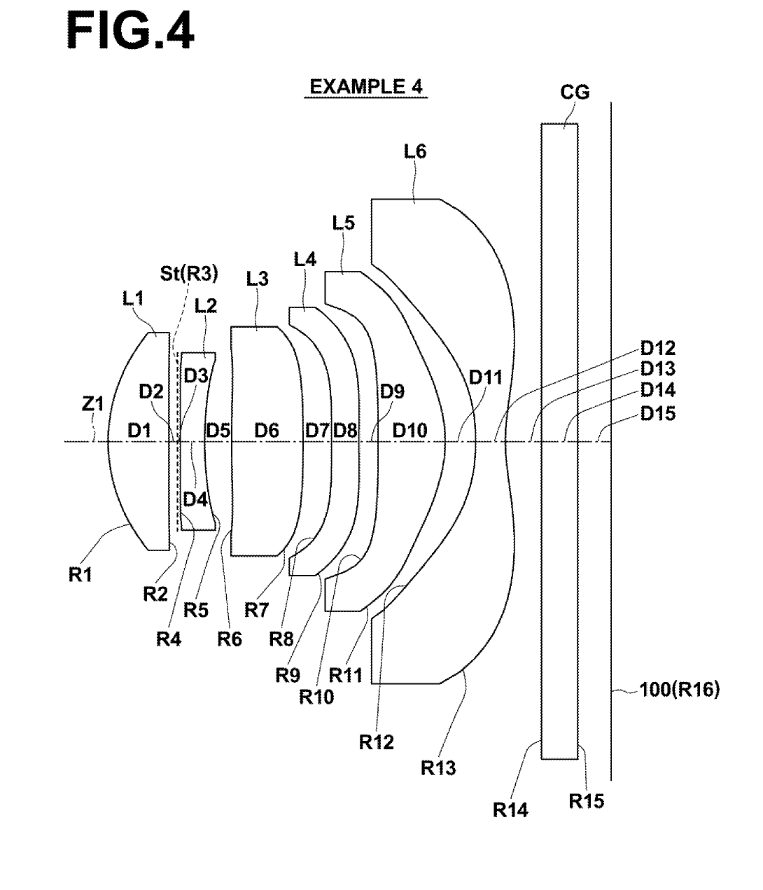

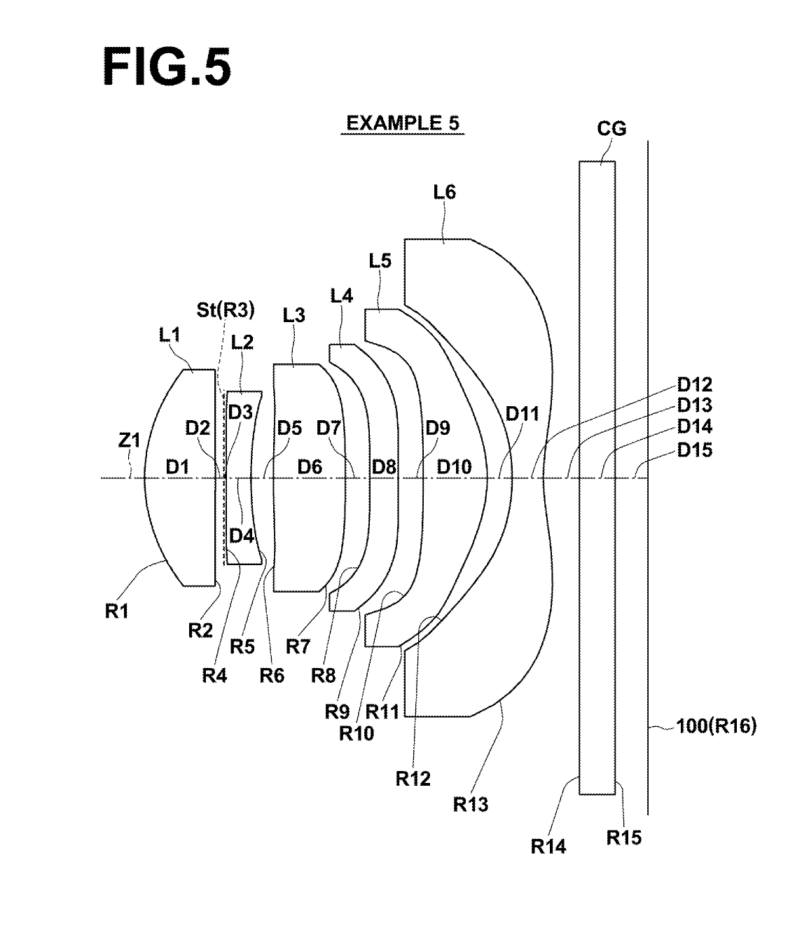

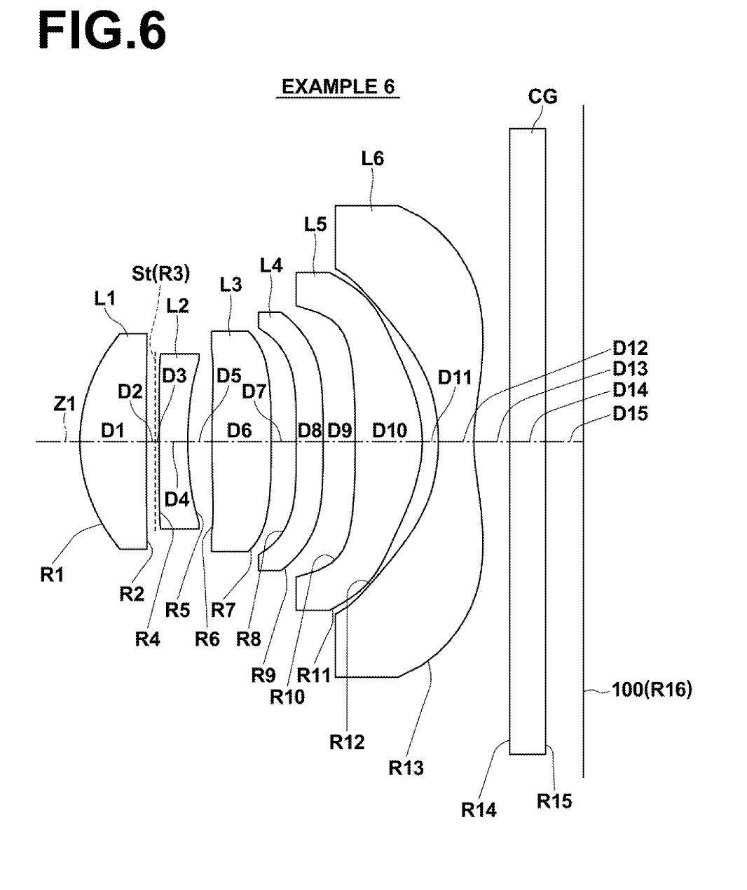

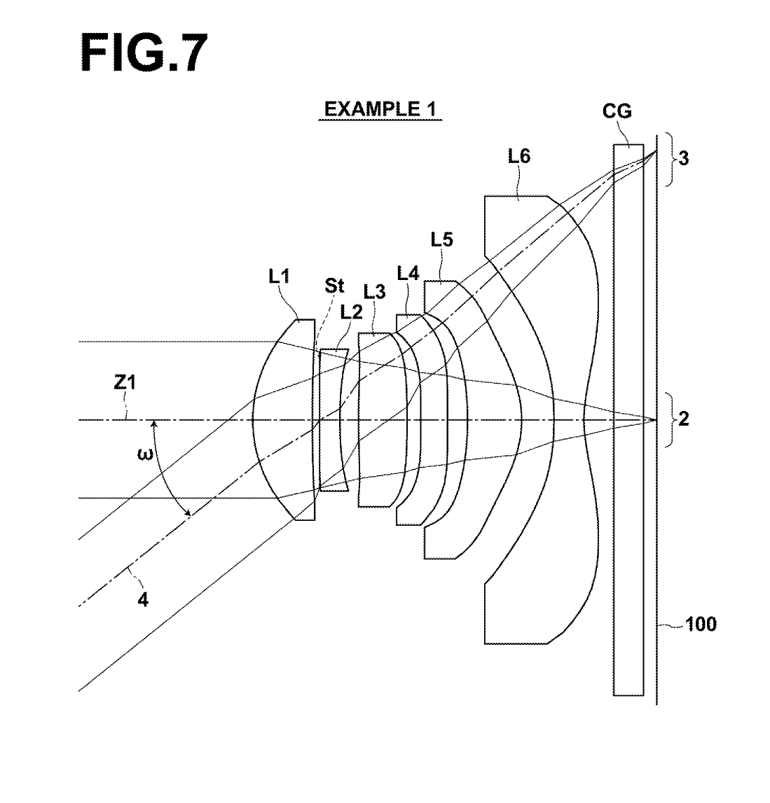

Similarly, FIG. 2 through FIG. 6 are sectional diagrams that illustrate second through sixth examples of lens configurations that correspond to Numerical Examples 2 through 6 (Table 3 through Table 12). In FIGS. 1 through 6, the symbol Ri represents the radii of curvature of ith surfaces, i being lens surface numbers that sequentially increase from the object side to the image side (imaging side), with the surface of a lens element most toward the object side designated as first. The symbol Di represents the distances between an ith surface and an i+1st surface along an optical axis Z1. Note that the basic configurations of the examples are the same, and therefore a description will be given of the imaging lens of FIG. 1 as a base, and the examples of FIGS. 2 through 6 will also be described as necessary. In addition, FIG. 7 is a diagram that illustrates the paths of light rays that pass through the imaging lens L of FIG. 1. FIG. 7 illustrates the paths of axial light beams 2 and maximum angle of view light beams 3 from an object at a distance of infinity, and a half value ω of a maximum angle of view. Note that a principal light ray 4 of the maximum angle of view light beams 3 is indicated by a single dot chained line.

The imaging lens L of the embodiment of the present invention is favorably employed in various imaging devices that employ imaging elements such as a CCD and a CMOS. The imaging lens L of the embodiment of the present invention is particularly favorable for use in comparatively miniature portable terminal devices, such as a digital still camera, a cellular telephone with a built in camera, a smart phone, a tablet type terminal, and a PDA. The imaging lens L is equipped with a first lens L1, a second lens L2, a third lens L3, a fourth lens L4, a fifth lens L5, and a sixth lens L6, provided in this order from the object side.

FIG. 14 schematically illustrates a cellular telephone as an imaging apparatus 1 according to an embodiment of the present invention. The imaging apparatus 1 of the embodiment of the present invention is equipped with the imaging lens L according to the embodiment of the present invention and an imaging element 100 (refer to FIG. 1) such as a CCD that outputs image signals corresponding to optical images formed by the imaging lens L. The imaging element 100 is provided at an image formation plane (imaging surface R16 in FIGS. 1 through 6) of the imaging lens L.

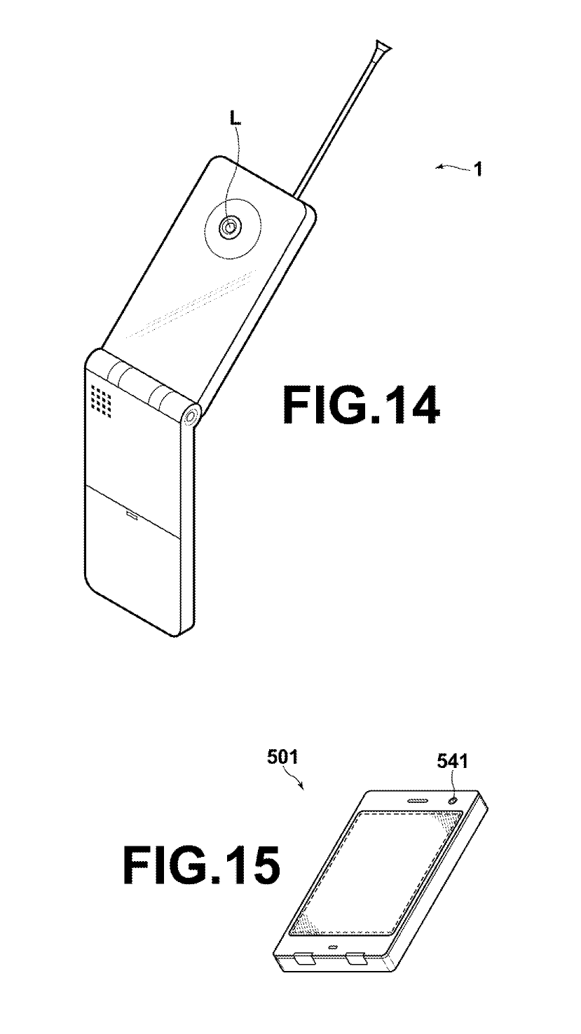

FIG. 15 schematically illustrates a smart phone as an imaging apparatus 501 according to an embodiment of the present invention. The imaging apparatus 501 of the embodiment of the present invention is equipped with a camera section 541 having the imaging lens L according to the embodiment of the present invention and an imaging element 100 (refer to FIG. 1) such as a CCD that outputs image signals corresponding to optical images formed by the imaging lens L. The imaging element 100 is provided at an image formation plane (imaging surface) of the imaging lens L.

Various optical members CG may be provided between the sixth lens L6 and the imaging element 100, depending on the configuration of the camera to which the lens is applied. A planar optical member such as a cover glass for protecting the imaging surface and an infrared cutoff filter may be provided, for example. In this case, a planar cover glass having a coating having a filtering effect such as an infrared cutoff filter coating or an ND filter coating, or a material that exhibits similar effects, may be utilized as the optical member CG.

Alternatively, the optical member CG may be omitted, and a coating may be administered on the sixth lens L6 to obtain the same effect as that of the optical member CG. In this case, the number of parts can be reduced, and the total length can be shortened.

It is preferable for the imaging lens L to be equipped with an aperture stop St positioned at the object side of the surface of the second lens L2 toward the object side. In the case that the aperture stop St is positioned at the object side of the surface of the second lens L2 toward the object side in this manner, increases in the incident angles of light rays that pass through the optical system and enter the image formation plane (imaging element) can be suppressed, particularly at peripheral portions of an imaging region. Note that the expression “positioned at the object side of the surface of the second lens L2 toward the object side” means that the position of the aperture stop in the direction of the optical axis is at the same position as the intersection of marginal axial rays of light and the surface of the second lens L2 toward the object side, or more toward the object side than this position. It is preferable for the apertures stop St to be positioned at the object side of the surface of the first lens L1 toward the object side, in order to cause this advantageous effect to become more prominent. Note that the expression “positioned at the object side of the surface of the first lens L1 toward the object side” means that the position of the aperture stop in the direction of the optical axis is at the same position as the intersection of marginal axial rays of light and the surface of the first lens L1 toward the object side, or more toward the object side than this position.

Alternatively, the apertures stop St may be positioned between the first lens L1 and the second lens L2. In this case, the total length can be shortened, while aberrations can be corrected in a well balanced manner by the lens positioned at the object side of the aperture stop St and the lenses positioned at the image side of the aperture stop St. In the embodiments, the lenses of the first through six Examples (FIGS. 1 through 6) are examples in which the aperture stop St is positioned between the first lens L1 and the second lens L2. Note that the aperture stops St illustrated in the figures do not necessarily represent the sizes or shapes thereof, but indicate the positions thereof on the optical axis Z1.

In the imaging lens L, the first lens L1 has a positive refractive power in the vicinity of the optical axis. This configuration is advantageous from the viewpoint of shortening the total length of the lens. In addition, the first lens L1 has a convex surface toward the object side in the vicinity of the optical axis. In this case, the positive refractive power of the first lens L1, which performs a substantial portion of the image forming function, can be sufficiently increased. As a result, shortening of the total length of the lens can be more favorably realized. In addition, the first lens L1 may be of a biconvex shape in the vicinity of the optical axis. In this case, the positive refractive power of the first lens L1 can be favorably secured, while suppressing the generation of spherical aberration. Alternatively, the first lens L1 may be of a meniscus shape having a convex surface toward the object side in the vicinity of the optical axis. In this case, a shortening of the total length can be favorably realized.

In addition, the second lens L2 has a negative refractive power in the vicinity of the optical axis. Thereby, longitudinal chromatic aberration and spherical aberration can be favorably corrected. In addition, the second lens L2 has a concave surface toward the object side in the vicinity of the optical axis. For this reason, spherical aberration and chromatic aberration can be more favorably corrected. Further, it is preferable for the second lens L2 to be of a biconcave shape in the vicinity of the optical axis. In this case, the negative refractive power of the second lens L2 can be sufficiently secured. As a result, various aberrations, which are generated at the first lens L1 having a positive refractive power, can be favorably corrected. In addition, this configuration is advantageous from the viewpoint of shortening the total length of the lens.

It is preferable for the third lens L3 to have a positive refractive power in the vicinity of the optical axis. In this case, positive refractive power can be distributed between the first lens L1 and the third lens L3. As a result, the positive refractive power of the imaging lens L can be sufficiently increased, and spherical aberration can be favorably corrected. In addition, increases in the incident angles of light rays that pass through the optical system and enter the image formation plane (imaging element) can be suppressed, particularly at intermediate angles of view, by the third lens L3 having a positive refractive power in the vicinity of the optical axis. In addition, the third lens L3 may be of a biconvex shape in the vicinity of the optical axis. In this case, the positive refractive power of the third lens L3 can be secured, while the generation of spherical aberration can be suppressed.

The fourth lens L4 has a negative refractive power in the vicinity of the optical axis. Thereby, lateral chromatic aberration can be favorably corrected. In addition, the fourth lens L4 may be of a biconcave shape in the vicinity of the optical axis. In this case, spherical aberration and longitudinal chromatic aberration can be favorably corrected. In addition, the fourth lens L4 may be of a meniscus shape having a convex surface toward the object side in the vicinity of the optical axis. In this case, the total length of the lens can be favorably shortened. Alternatively, the fourth lens L4 may be of a meniscus shape having a convex surface toward the image side in the vicinity of the optical axis. In this case, the generation of astigmatism can be suppressed.

The fifth lens L5 has a positive refractive power in the vicinity of the optical axis. This configuration is advantageous from the viewpoint of shortening the total length, and enables spherical aberration and longitudinal chromatic aberration to be favorably corrected. In addition, it is preferable for the fifth lens L5 to have a concave surface toward the object side in the vicinity of the optical axis. In this case, the generation of astigmatism can be suppressed, while enabling a shortening of the total length and a widening of the angle of view. In addition, it is preferable for the fifth lens L5 to be of a meniscus shape having a concave surface toward the object side in the vicinity of the optical axis. In this case, the generation of astigmatism can be suppressed.

The sixth lens L6 has a negative refractive power in the vicinity of the optical axis. For this reason, if the first lens L1 through the fifth lens L5 are considered to be a positive lens group, and the sixth lens L6 is considered to be a negative lens group in the imaging lens L, the imaging lens L can have a telephoto type configuration as a whole. Thereby, the rearward principal point of the imaging lens L can be moved toward the object side, and shortening of the total length of the lens can be favorably realized. In addition, field curvature can be favorably corrected by the sixth lens L6 having a negative refractive power in the vicinity of the optical axis.

In addition, it is preferable for the sixth lens L6 to have a concave surface toward the object side in the vicinity of the optical axis. In this case, securing the negative refractive power of the sixth lens L6 will be facilitated, which is advantageous from the viewpoint of shortening the total length of the lens. The burden of bearing a negative refractive power borne by the surface of the sixth lens L6 toward the image side is reduced in the case that the sixth lens L6 has a concave surface toward the object side in the vicinity of the optical axis compared to a case in which the sixth lens L6 has a convex surface toward the object side in the vicinity of the optical axis. Therefore, increases in the incident angles of light rays that pass through the optical system at and enter the image formation plane (imaging element) can be favorably suppressed, particularly at intermediate angles of view. In addition, it is preferable for the sixth lens L6 to have a concave surface toward the image side in the vicinity of the optical axis. In this case, a shortening of the total length can be more favorably realized, while field curvature can be favorably corrected.

In addition, it is preferable for the surface of the sixth lens L6 toward the image side to be of an aspherical shape having at least one inflection point at a position in an inwardly radial direction from the intersection of a principal light ray at a maximum angle of view and the surface of the sixth lens L6 toward the image side to the optical axis. By adopting this configuration, increases in the incident angles of light rays that pass through the optical system at and enter the image formation plane (imaging element) can be suppressed, particularly at the peripheral portions of the imaging region. In addition, distortion can be favorably corrected, by the surface of the sixth lens L6 toward the image side being of an aspherical shape having at least one inflection point at a position in an inwardly radial direction from the intersection of a principal light ray at a maximum angle of view and the surface of the sixth lens L6 toward the image side to the optical axis. Note that the “inflection point” on the surface of the sixth lens L6 toward the image side refers to a point at which the shape of the surface of the sixth lens L6 toward the image side changes from a convex shape to a concave shape (or from a concave shape to a convex shape) with respect to the image side. In addition, in the present specification, the expression “a position in an inwardly radial direction from the intersection of a principal light ray at a maximum angle of view and the surface toward the image side to the optical axis” refers to positions at the intersection of a principal light ray at a maximum angle of view and the surface toward the image side to the optical axis and positions radially inward toward the optical axis from these positions. In addition, the inflection point on the surface of the sixth lens L6 toward the image side may be provided positions at the intersection of a principal light ray at a maximum angle of view and the surface of the sixth lens L6 toward the image side to the optical axis and at any desired position radially inward toward the optical axis from these positions.

In addition, in the case that each of the first lens L1 through the sixth lens L6 that constitute the imaging lens L is a single lens, not a cemented lens, the number of lens surfaces will be greater than that for a case in which any of the first lens L1 through the sixth lens L6 is a cemented. Therefore, the degree of freedom in the design of each lens will increase. As a result, shortening of the total length and increase in resolution will be facilitated.

According to the imaging lens L described above, the configurations of each of the first lens L1 through the sixth lens L6 are optimized as lens elements in a lens configuration having a total of six lenses. Therefore, a lens system that achieves a shortened total length and a widened angle of view, which is compatible with imaging elements that satisfy demand for a greater number of pixels and has high imaging performance from a central angle of view to peripheral angles of view, can be realized.

It is preferable for at least one of the surfaces of each of the first lens L1 through the sixth lens L6 of the imaging lens L to be an aspherical surface, in order to improve performance.

Next, the operation and effects of conditional formulae related to the imaging lens L will be described in greater detail. Note that it is preferable for the imaging lens L to satisfy any one of the following conditional formulae, or arbitrary combinations of the following conditional formulae. It is preferable for the conditional formulae to be satisfied to be selected as appropriate according to the items required of the imaging lens L. It is preferable for the focal length f3 of the third lens L3 and the focal length f1 of the first lens L1 to satisfy Conditional Formula (1) below.

2.4<f3/f1<4.6 (1)

Conditional Formula (1) defines a preferable range of numerical values for the ratio of the focal length f3 of the third lens L3 with respect to the focal length f1 of the first lens L1. By maintaining the refractive power of the third lens L3 with respect to the refractive power of the first lens L1 such that the value of f3/f1 is not less than or equal to the lower limit defined in Conditional Formula (1), the positive refractive power of the third lens L3 will not become excessively weak with respect to the refractive power of the first lens L1. Such a configuration is advantageous from the viewpoint of shortening the total length of the lens while widening the angle of view. By suppressing the refractive power of the third lens L3 with respect to the refractive power of the first lens L1 such that the value of f3/f1 is not greater than or equal to the upper limit defined in Conditional Formula (1), the positive refractive power of the third lens L3 will not become excessively strong with respect to the refractive power of the first lens L1. As a result, the positive refractive power of the imaging lens L can be appropriately distributed between the first lens L1 and the third lens L3, and spherical aberration can be favorably corrected. It is more preferable for Conditional Formula (1-1) to be satisfied, and even more preferable for Conditional Formula (1-2) to be satisfied, in order to cause these advantageous effects to become more prominent.

2.8<f3/f1<4.5 (1-1)

3<f3/f1<4.4 (1-2)

It is preferable for the focal length f6 of the sixth lens L6 and the focal length f1 of the first lens L1 to satisfy Conditional Formula (2) below.

−2.1<f1/f6<−1.54 (2)

Conditional Formula (2) defines a preferable range of numerical values for the ratio of the focal length f1 of the first lens L1 with respect to the focal length f6 of the sixth lens L6. It is preferable to secure the refractive power of the first lens L1 with respect to the refractive power of the sixth lens L6 such that the value of f1/f6 is not less than or equal to the lower limit defined in Conditional Formula (2). In this case, the refractive power of the first lens L1 will not become excessively weak with respect to the negative refractive power of the sixth lens L6. Such a configuration is advantageous from the viewpoint of shortening the total length of the lens, because the rearward principal point of the imaging lens L can be moved toward the object side. In addition, by maintaining the refractive power of the first lens L1 with respect to the refractive power of the sixth lens L6 such that the value of f1/f6 is not greater than or equal to the upper limit defined in Conditional Formula (2), the refractive power of the first lens L1 will not become excessively strong with respect to the negative refractive power of the sixth lens L6. As a result, at least a length corresponding to a necessary amount of back focus can be secured. It is more preferable for Conditional Formula (2-1) to be satisfied, in order to cause these advantageous effects to become more prominent.

−2<f1/f6<−1.55 (2-1)

In addition, it is preferable for the combined focal length f34 of the third lens L3 and the fourth lens L4 and the focal length f of the entire system to satisfy Conditional Formula (3) below.

2.9<f34/f<8 (3)

Conditional Formula (3) defines a preferable range of numerical values for the ratio of the combined focal length f34 of the third lens L3 and the fourth lens L4 with respect to the focal length f of the entire system. By maintaining the combined refractive power of the third lens L3 and the fourth lens L4 such that the value of f34/f is not less than or equal to the lower limit defined in Conditional Formula (3), the combined refractive power of the third lens L3 and the fourth lens L4 will not become excessively strong with respect to the refractive power of the entire system, and various aberrations can be favorably corrected. By securing the combined refractive power of the third lens L3 and the fourth lens L4 such that the value of f34/f is not greater than or equal to the upper limit defined in Conditional Formula (3), combined refractive power of the third lens L3 and the fourth lens L4 will not become excessively weak with respect to the refractive power of the entire system. As a result, a balance of the refractive powers of the third lens L3 and the fourth lens L4 can be favorably maintained, and the total length of the lens can be favorably shortened. It is more preferable for Conditional Formula (3-1) to be satisfied, and even more preferable for Conditional Formula (3-2) to be satisfied, in order to cause these advantageous effects to become more prominent.

2.95<f34/f<7.1 (3-1)

3<f34/f<6.5 (3-2)

In addition, it is preferable for the paraxial radius of curvature L1f of the surface of the first lens L1 toward the object side and the paraxial radius of curvature L1r of the surface of the first lens L1 toward the image side to satisfy Conditional Formula (4) below.

0.85<(L1r+L1f)/(L1r−L1f)<1.16 (4)

Conditional Formula (4) defines a preferable range of numerical values related to the paraxial radius of curvature L1f of the surface of the first lens L1 toward the object side and the paraxial radius of curvature L1r of the surface of the first lens L1 toward the image side. By configuring the imaging lens such that the value of (L1r+L1f)/(L1r−L1f) is not less than or equal to the lower limit defined in Conditional Formula (4), increasing the refractive power of the first lens L1 is facilitated. Therefore, the total length of the lens can be favorably shortened. By configuring the imaging lens such that the value of (L1r+L1 f)/(L1r−L1f) is not greater than or equal to the upper limit defined in Conditional Formula (4), the generation of spherical aberration can be favorably suppressed. It is preferable for Conditional Formula (4-1) to be satisfied, in order to cause these advantageous effects to become more prominent.

0.87<(L1r+L1f)/(L1r−L1f)<1.15 (4-1)

In addition, it is preferable for the paraxial radius of curvature L5f of the surface of the fifth lens L5 toward the object side and the paraxial radius of curvature L5r of the surface of the fifth lens L5 toward the image side to satisfy Conditional Formula (5) below.

−2.4<(L5r+L5f)/(L5r−L5f)<−0.9 (5)

Conditional Formula (5) defines a preferable range of numerical values related to the paraxial radius of curvature L5f of the surface of the fifth lens L5 toward the object side and the paraxial radius of curvature L5r of the surface of the fifth lens L5 toward the image side. By configuring the imaging lens such that the value of (L5r+L5f)/(L5r−L5f) is not less than or equal to the lower limit defined in Conditional Formula (5), increasing the refractive power of the fifth lens L5 is facilitated. As a result, the total length of the lens can be favorably shortened. By configuring the imaging lens such that the value of (L5r+L5f)/(L5r−L5f) is not greater than or equal to the upper limit defined in Conditional Formula (5), spherical aberration and longitudinal chromatic aberration can be favorably corrected. It is more preferable for Conditional Formula (5-1) to be satisfied, and even more preferable for Conditional Formula (5-2) to be satisfied, in order to cause these advantageous effects to become more prominent.

−2.2<(L5r+L5f)/(L5r−L5f)<−0.95 (5-1)

−2.1<(L5r+L5f)/(L5r−L5f)<−1 (5-2)

In addition, it is preferable for the focal distance f of the entire system, the half value ω of a maximum angle of view when in a state of focus on an object at infinity, and the paraxial radius of curvature L6r of the surface of the sixth lens L6 toward the image side to satisfy Conditional Formula (6) below.

0.5<f·tan ω/L6r<20 (6)

Conditional Formula (6) defines a preferable range of numerical values for the ratio of a paraxial image height (f·tan ω) with respect to the paraxial radius of curvature L6r of the surface of the sixth lens L6 toward the image side. By setting the paraxial image height (f·tan ω) with respect to the paraxial radius of curvature L6r of the surface of the sixth lens L6 toward the image side such that the value of f·tan ω/L6r is not less than or equal to the lower limit defined in Conditional Formula (6), the absolute value of the paraxial radius of curvature L6r of the surface of the sixth lens L6 toward the image side, which is the surface most toward the image side in the imaging lens L, will not be excessively large with respect to the paraxial image height (f·tan ω). As a result, spherical aberration, longitudinal chromatic aberration, and field curvature can be sufficiently corrected while realizing a shortening of the total length. Note that field curvature can be favorably corrected from a central angle of view to peripheral angles of view in the case that in the case that the sixth lens L6 is of an aspherical shape having a concave surface toward the image side and at least one inflection point as illustrated in the imaging lenses L of each of the Examples, and in the case that the lower limit of Conditional Formula (6) is satisfied. Therefore, this configuration is advantageous from the viewpoint of realizing a wide angle of view. In addition, by setting the paraxial image height (f·tan ω) with respect to the paraxial radius of curvature L6r of the surface of the sixth lens L6 toward the image side such that the value of f·tan ω/L6r is not greater than or equal to the upper limit defined in Conditional Formula (6), the absolute value of the paraxial radius of curvature L6r of the surface of the sixth lens L6 toward the image side, which is the surface most toward the image side in the imaging lens, will not be excessively small with respect to the paraxial image height (f·tan ω). Thereby, increases in the incident angle of light rays that pass through the optical system and enter the image formation plane (imaging element) can be suppressed, particularly at intermediate angles of view. It is preferable for Conditional Formula (6-1) to be satisfied, in order to cause these advantageous effects to become more prominent.

1<f·tan ω/L6r<15 (6-1)

Here, two preferred examples of configurations of the imaging lens L and the advantageous effects obtained thereby will be described. Note that these two preferred examples may adopt the preferred configurations of the imaging lens L described above as appropriate.

The first example is an imaging lens L consisting essentially of six lenses, including: a first lens having a positive refractive power and a convex surface toward the object side; a second lens having a negative refractive power and a concave surface toward the object side; a third lens having a positive refractive power; a fourth lens having a negative refractive power; a fifth lens having a positive refractive power; and a sixth lens having a negative refractive power, provided in this order from the object side. The image lens L satisfies Conditional Formula (1). According to the first example, a widening of the angle of view and a shortening of the total length of the lens can be achieved, while favorably correcting spherical aberration.

In contrast, the imaging lenses disclosed in U.S. Patent Application Publication No. 20130235473, Taiwanese Patent Publication No. 201331623, Taiwanese Patent Publication No. 201326883, Taiwanese Patent Publication No. 201305596, and U.S. Patent Application Publication No. 20120314301, for example, do not satisfy the lower limit defined in Conditional Formula (1). Therefore, the shortening of the total length of the lenses is not sufficient. In addition, a further shortening of the total length of the lens is also desired for the imaging lenses disclosed in U.S. Patent Application Publication Nos. 20130003193 and 20130070346 as well. Further, the maximum angles of view of the imaging lenses disclosed in Taiwanese Patent Publication No. 201331623, U.S. Patent Application Publication No. 20130003193, U.S. Patent Application Publication No. 20120314301, and U.S. Patent Application Publication No. 20130070346 are 70 degrees, which is too small. Therefore, a further widening of the angle of view is desired.

The second example is an imaging lens L consisting essentially of six lenses, including: a first lens having a positive refractive power and a convex surface toward the object side; a second lens of a biconcave shape; a third lens having a positive refractive power; a fourth lens having a negative refractive power; a fifth lens having a positive refractive power and a concave surface toward the object side; and a sixth lens having a negative refractive power and a concave surface toward the object side, provided in this order from the object side. According to the second example, the second lens L2 in particular is of a biconcave shape in the vicinity of the optical axis. This configuration is advantageous from the viewpoint of shortening the total length of the lens. In addition, the fifth lens L5 has a concave surface toward the object side in the vicinity of the optical axis. Therefore, the generation of astigmatism can be favorably suppressed, while realizing a widened angle of view and a shortened total length. In addition, the sixth lens L6 has a concave surface toward the object side in the vicinity of the optical axis. This configuration is advantageous from the viewpoint of shortening the total length of the lens, and can also suppress increases in the incident angles of light rays that pass through the optical system and enter the image formation plane (imaging element) at intermediate angles of view.

In contrast, in the imaging lenses disclosed in U.S. Patent Application Publication No. 20130235473 and Taiwanese Patent Publication No. 201331623, for example, the fifth lens has a convex surface toward the object side, and more favorable correction of astigmatism is required with respect to a degree of imaging performance required for the increased number of pixels in imaging apparatuses such as cellular telephones. In addition, the total lengths of the imaging lenses disclosed in U.S. Patent Application Publication No. 20130235473, Taiwanese Patent Publication No. 201331623, Taiwanese Patent Publication No. 201326883, U.S. Patent Application Publication No. 20130003193, Taiwanese Patent Publication No. 201305596, U.S. Patent Application Publication No. 20120314301, and U.S. Patent Application Publication No. 20130070346 are not sufficiently shortened. For this reason, a further shortening of the total lengths of these lenses is required. In addition, the maximum angles of view of the imaging lenses disclosed in Taiwanese Patent Publication No. 201331623, U.S. Patent Application Publication No. 20130003193, U.S. Patent Application Publication No. 20120314301, and U.S. Patent Application Publication No. 20130070346 are 70 degrees, which is too small. Therefore, a further widening of the angles of view is required.

As described above, in the imaging lens L according to the embodiments of the present invention, the configurations of each lens element is optimized in a lens configuration having a total of six lenses. Therefore, a lens system that achieves a shortened total length and a widened angle of view, which is compatible with imaging elements that satisfy demand for a greater number of pixels and has high imaging performance from a central angle of view to peripheral angles of view, can be realized.

In addition, in the case that the lens configurations of each of the first lens L1 through the sixth lens L6 are set such that the maximum angle of view in a state focused on an object at infinity is 74 degrees or greater as in the imaging lenses of the first through sixth embodiments, the imaging lens L may be favorably applied for use in imaging apparatuses such as cellular telephones, and can meet demands regarding shortening of the total length of the lens and widening of the angle of view. The imaging lenses of the first through sixth embodiments are capable of meeting demand to obtain an image by photography by an imaging apparatus such as a cellular telephone with a wide angle of view and high resolution, then obtaining a desired image portion by enlarging the photographed image, for example. For example, the imaging lenses disclosed in U.S. Patent Application Publication No. 20130235473, Taiwanese Patent Publication No. 201331623, Taiwanese Patent Publication No. 201326883, U.S. Patent Application Publication No. 20130003193, Taiwanese Patent Publication No. 201305596, U.S. Patent Application Publication No. 20120314301, and U.S. Patent Application Publication No. 20130070346 are configured such that a ratio TTL/ImgH of a distance TTL from the surface of a first lens toward the object side to an image formation plane along the optical axis (back focus is an air converted length) with respect to a half value of an image size ImgH is within a range from 1.57 to 2.03, whereas the embodiments described in the present specification are favorably configured such that the values of TTL/ImgH are within a range from 1.45 to 1.52.

In addition, further improved imaging performance can be realized by satisfying the above preferred conditions appropriately. In addition, the imaging apparatuses according to the embodiments of the present invention output image signals corresponding to optical images formed by the high performance imaging lenses according to the embodiments of the present invention. Therefore, photographed images having high resolution from a central angle of view to peripheral angles of view can be obtained.

Next, specific examples of numerical values of the imaging lens of the present invention will be described. A plurality of examples of numerical values will be summarized and explained below.

Table 1 and Table 2 below show specific lens data corresponding to the configuration of the imaging lens illustrated in FIG. 1. Table 1 shows basic lens data of the imaging lens, and Table 2 shows data related to aspherical surfaces. In the lens data of Table 1, ith lens surface numbers that sequentially increase from the object side to the image side, with the lens surface at the most object side designated as first, are shown in the column Si for the imaging lens of Example 1. The radii of curvature (mm) of ith surfaces from the object side corresponding to the symbols Ri illustrated in FIG. 1 are shown in the column Ri. Similarly, the distances (mm) between an ith surface Si and an i+1st surface Si+1 from the object side along the optical axis Z are shown in the column Di. The refractive indices of jth optical elements from the object side with respect to the d line (wavelength: 587.6 nm) are shown in the column Ndj. The Abbe's numbers of the jth optical elements with respect to the d line are shown in the column vdj.

Table 1 also shows the aperture stop St and the optical member CG. In Table 1, “(St)” is indicated along with a surface number in the row of the surface number of the surface that corresponds to the aperture stop St, and “IMG” is indicated along with a surface number in the row of the surface number of the surface that corresponds to the imaging surface. The signs of the radii of curvature are positive for surface shapes having convex surfaces toward the object side, and negative for surface shapes having convex surfaces toward the image side. Note that the values of the focal length f (mm) of the entire system, the back focus Bf (mm), the F number Fno. and the maximum angle of view 2ω(°) in a state focused on an object at infinity are shown as data above the lens data. Note that the back focus Bf is represented as an air converted value.

In the imaging lens of Example 1, both of the surfaces of the first lens L1 through the sixth lens L6 are all aspherical in shape. In the basic lens data of Table 1, numerical values of radii of curvature in the vicinity of the optical axis (paraxial radii of curvature) are shown as the radii of curvature of the aspherical surfaces.

Table 2 shows aspherical surface data of the imaging lens of Example 1. In the numerical values shown as the aspherical surface data, the symbol “E” indicates that the numerical value following thereafter is a “power index” having 10 as a base, and that the numerical value represented by the index function having 10 as a base is to be multiplied by the numerical value in front of “E”. For example, “1.0E-02” indicates that the numerical value is “1.0·10⁻²”.

The values of coefficients An and KA represented by the aspherical surface shape formula (A) below are shown as the aspherical surface data. In greater detail, Z is the length (mm) of a normal line that extends from a point on the aspherical surface having a height h to a plane (a plane perpendicular to the optical axis) that contacts the apex of the aspherical surface.

$$Z = \frac{C \times {h}^{2}}{1 + \sqrt{1 - KA \times {C}^{2} \times {h}^{2}}} + {\sum }_{n} An \times {h}^{n} \qquad ( A )$$

wherein: Z is the depth of the aspherical surface (mm), h is the distance from the optical axis to the surface of the lens (height) (mm), C is the paraxial curvature=1/R (R is the paraxial radius of curvature), An is an nth ordinal aspherical surface coefficient (n is an integer 3 or greater), and KA is an aspherical surface coefficient.

Specific lens data corresponding to the configurations of the imaging lenses illustrated in FIG. 2 through FIG. 6 are shown in Table 3 through Table 12 as Example 2 through Example 6. In the imaging lenses of Examples 1 through 6, both of the surfaces of the first lens L1 through the sixth lens L6 are all aspherical surfaces.

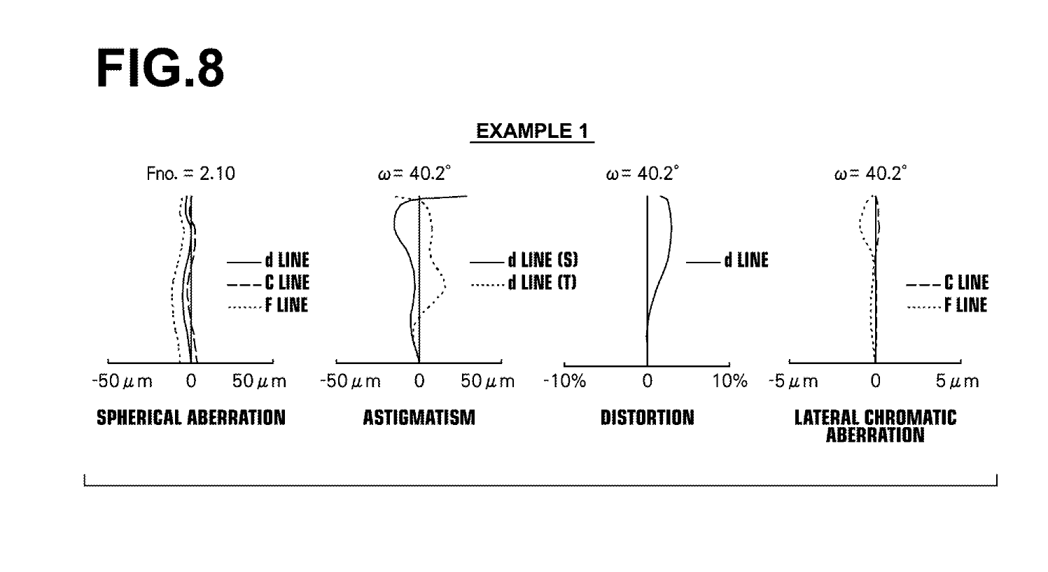

FIG. 8 is a collection of diagrams that illustrate aberrations of the imaging lens of Example 1, wherein the diagrams illustrate the spherical aberration, the astigmatism, the distortion, and the lateral chromatic aberration (chromatic aberration of magnification) of the imaging lens of Example 1, respectively, in this order from the left side of the drawing sheet. Each of the diagrams that illustrate the spherical aberration, the astigmatism (field curvature), and the distortion illustrate aberrations using the d line (wavelength: 587.6 nm) as a reference wavelength. The diagram that illustrates spherical aberration also shows aberrations related to the F line (wavelength: 486.1 nm), the C line (wavelength: 656.3 nm) and the g line (wavelength: 435.8 nm). The diagram that illustrates lateral chromatic aberration shows aberrations related to the F line, the C line, and the g line. In the diagram that illustrates astigmatism, aberration in the sagittal direction (S) is indicated by a solid line, while aberration in the tangential direction (T) is indicated by a broken line. In addition, “Fno.” denotes F numbers, and “ω” denotes a half value of the maximum angle of view in a state focused on an object at infinity.

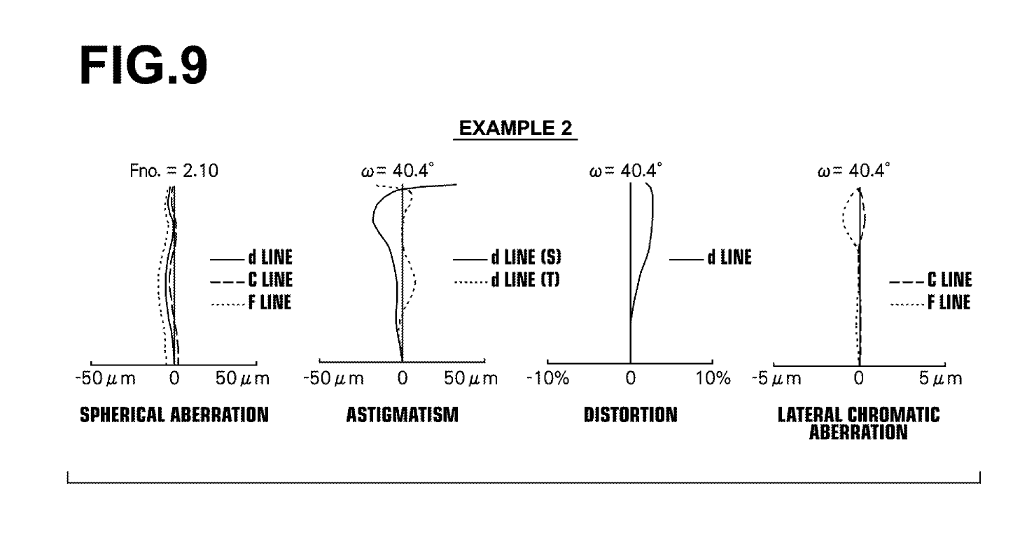

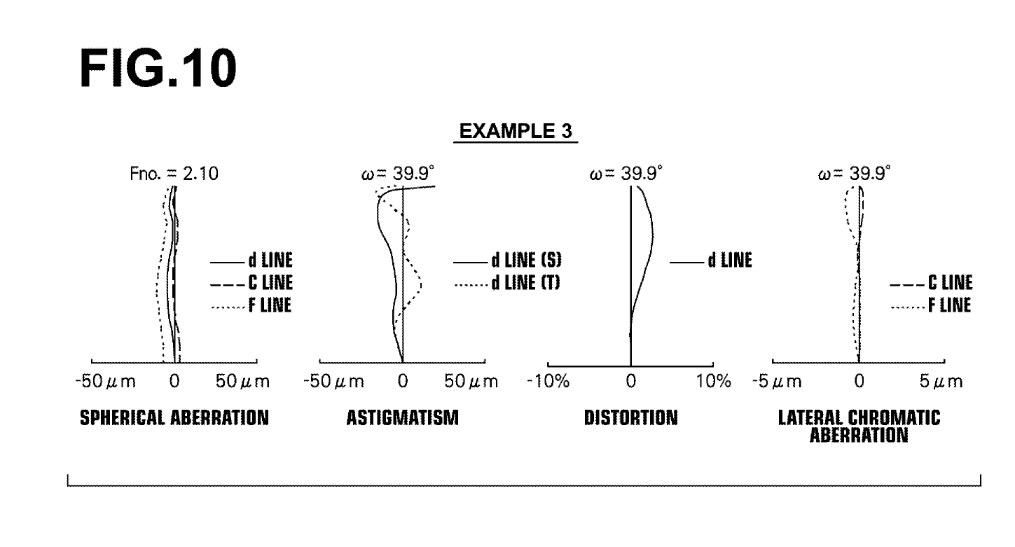

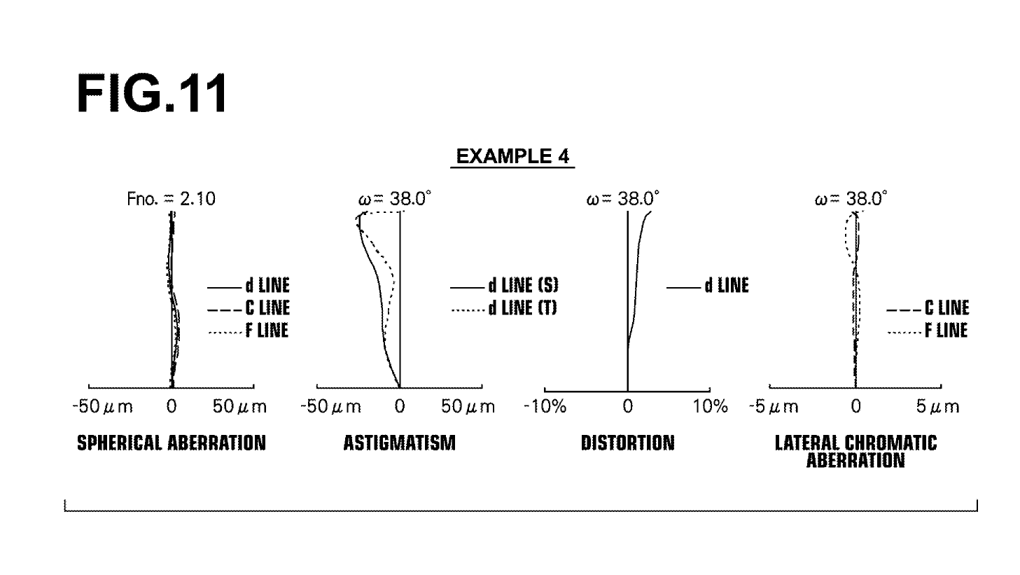

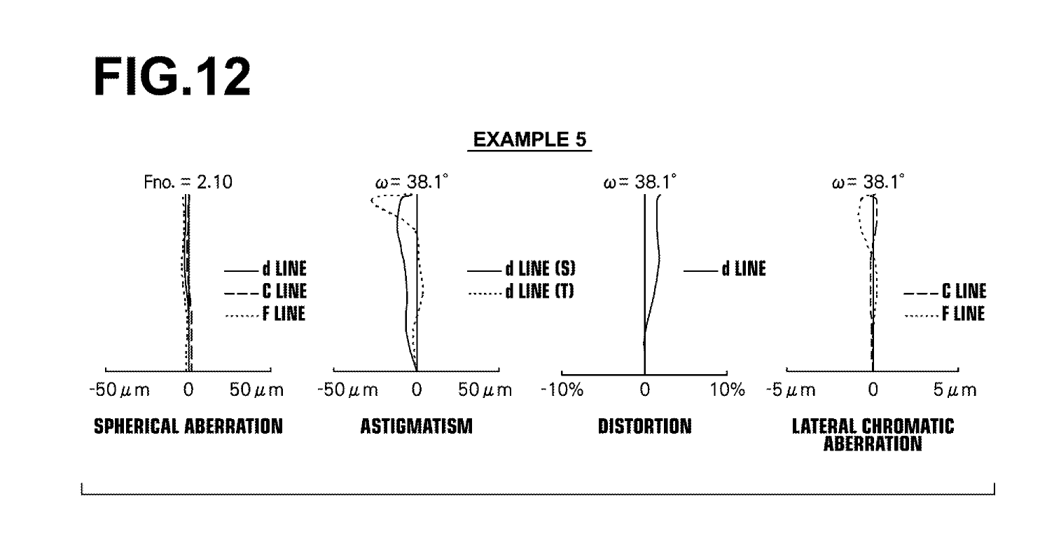

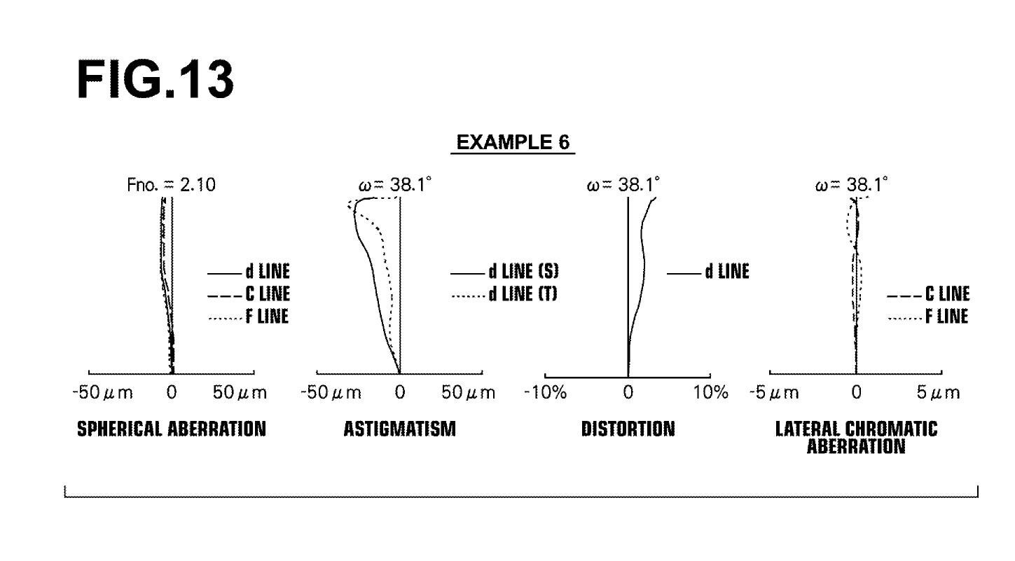

Similarly, the aberrations of the imaging lens of Example 2 through Example 7 are illustrated in FIG. 9 through FIG. 13. The diagrams that illustrate aberrations of FIG. 9 through FIG. 13 are all for cases in which the object distance is infinity.

Table 13 shows values corresponding to Conditional Formulae (1) through (6), respectively summarized for each of Examples 1 through 6.

As can be understood from each set of numerical value data and from the diagrams that illustrate aberrations, each of the Examples realize a shortening of the total length of the lens, a widened angle of view, and high imaging performance.

Note that the imaging lens of the present invention is not limited to the embodiments and Examples described above, and various modifications are possible. For example, the values of the radii of curvature, the distances among surfaces, the refractive indices, the Abbe's numbers, the aspherical surface coefficients, etc., are not limited to the numerical values indicated in connection with the Examples of numerical values, and may be other values.

In addition, the Examples are described under the presumption that they are to be utilized with fixed focus. However, it is also possible for configurations capable of adjusting focus to be adopted. It is possible to adopt a configuration, in which the entirety of the lens system is fed out or a portion of the lenses is moved along the optical axis to enable automatic focus, for example.

TABLE 1
Example 1
f = 2.75, Bf = 0.53, Fno. = 2.10, 2ω = 80.4

| Si | Ri | Di | Ndj | νdj |
|---|---|---|---|---|
| *1 | 1.1215 | 0.4999 | 1.544 | 55.9 |
| *2 | 17.7661 | 0.0602 | | |
| 3 (St) | ∞ | 0.0002 | | |
| *4 | −40.8427 | 0.1698 | 1.650 | 21.4 |
| *5 | 3.1531 | 0.1562 | | |
| *6 | 7.0860 | 0.4073 | 1.544 | 55.9 |
| *7 | −12.0573 | 0.1157 | | |
| *8 | −79.1998 | 0.2244 | 1.650 | 21.4 |
| *9 | 48.2640 | 0.1668 | | |
| *10 | −2.6460 | 0.4547 | 1.544 | 55.9 |
| *11 | −0.8740 | 0.2703 | | |
| *12 | −2.7387 | 0.2502 | 1.544 | 55.9 |
| *13 | 1.0813 | 0.2500 | | |
| *14 | ∞ | 0.2500 | 1.517 | 64.2 |
| *15 | ∞ | 0.1107 | | |
| 16(IMG) | ∞ | | | |

*aspherical surface

TABLE 2
Example 1: Aspherical Surface Data

| Surface | | | | | |
|---|---|---|---|---|---|
| Number | KA | A4 | A6 | A8 | A10 |
| 1 | 4.3723488E−01 | 4.2369439E−02 | 7.5771309E−02 | −1.4497383E−01 | 3.2201837E−01 |
| 2 | −3.6348121E+03 | 1.0022808E−01 | −1.5393741E−01 | 1.7271625E−01 | −2.3853193E−01 |
| 4 | −1.0773215E+04 | 7.2711807E−02 | 7.0516116E−02 | −6.9383848E−02 | 2.1622288E−01 |
| 5 | −3.8894415E+00 | 8.7140389E−02 | 1.8151189E−01 | 3.5228661E−01 | −2.1846000E+00 |
| 6 | 9.5625926E+01 | −1.5865063E−01 | −1.1126918E−01 | 1.3375421E−01 | −7.9054539E−01 |
| 7 | 1.8279905E+02 | −2.4830084E−01 | −1.5879462E−01 | 1.8890622E−01 | −8.0306676E−01 |
| 8 | 3.9356039E+03 | −5.0699724E−01 | −3.6807460E−01 | 3.4289822E−01 | 1.3611158E−01 |
| 9 | −7.2036459E+03 | −3.3682434E−01 | −1.7889945E−01 | 1.7450340E−02 | 1.8309755E−01 |
| 10 | −2.9766420E+00 | −1.1164005E−01 | −2.4663539E−01 | 1.6054920E+00 | −5.3524363E+00 |
| 11 | −2.1976792E+00 | −1.2096289E−01 | 3.2571100E−02 | 6.1376343E−01 | −6.4456539E−01 |
| 12 | −4.7213150E+00 | −5.2076929E−01 | 8.0038035E−01 | −6.6012279E−01 | 3.1749564E−01 |
| 13 | −9.0622015E+00 | −2.8009327E−01 | 3.5809567E−01 | −3.1709396E−01 | 1.8092625E−01 |

| Surface | | | |
|---|---|---|---|
| Number | A12 | A14 | A16 |
| 1 | −3.4030500E−01 | — | — |
| 2 | 1.7643148E−01 | — | — |
| 4 | 1.2203154E−02 | — | — |
| 5 | 4.1554492E+00 | — | — |
| 6 | −3.7518988E−01 | — | — |
| 7 | −5.3710641E−01 | — | — |
| 8 | −1.3932657E+00 | — | — |
| 9 | −4.5836607E−02 | — | — |
| 10 | 8.8921747E+00 | −7.9210963E+00 | 2.4401763E+00 |
| 11 | −1.4940559E−01 | 3.7639879E−01 | −1.1444077E−01 |
| 12 | −1.2104895E−01 | 4.7039803E−02 | −9.9713053E−03 |
| 13 | −6.4450917E−02 | 1.2704358E−02 | −1.0419347E−03 |

TABLE 3
Example 2
f = 2.72, Bf = 0.54, Fno. = 2.10, 2ω = 80.8

| Si | Ri | Di | Ndj | νdj |
|---|---|---|---|---|
| *1 | 1.1278 | 0.4847 | 1.544 | 55.9 |
| *2 | 26.5726 | 0.0598 | | |
| 3 (St) | ∞ | 0.0000 | | |
| *4 | −34.0228 | 0.1555 | 1.650 | 21.4 |
| *5 | 3.0275 | 0.1636 | | |
| *6 | 7.0222 | 0.3791 | 1.544 | 55.9 |
| *7 | −11.0191 | 0.1179 | | |
| *8 | 57.1151 | 0.2132 | 1.650 | 21.4 |
| *9 | 12.3185 | 0.1564 | | |
| *10 | −3.0717 | 0.4610 | 1.544 | 55.9 |
| *11 | −0.8830 | 0.2924 | | |
| *12 | −2.6793 | 0.2502 | 1.544 | 55.9 |
| *13 | 1.0838 | 0.2500 | | |
| *14 | ∞ | 0.2500 | 1.517 | 64.2 |
| *15 | ∞ | 0.1208 | | |
| 16(IMG) | ∞ | | | |

*aspherical surface

TABLE 4
Example 2: Aspherical Surface Data

| Surface | | | | | |
|---|---|---|---|---|---|
| Number | KA | A4 | A6 | A8 | A10 |
| 1 | 4.4788497E−01 | 4.6326807E−02 | 5.9194026E−02 | −1.2590738E−01 | 3.2511782E−01 |
| 2 | −9.6387712E+03 | 9.5222950E−02 | −1.3820395E−01 | 1.7052336E−01 | −2.4308622E−01 |
| 4 | −3.9671724E+03 | 7.3871615E−02 | 5.7936821E−02 | −3.5126026E−02 | 2.4505973E−01 |
| 5 | −5.0241131E+00 | 8.2379848E−02 | 1.9708295E−01 | 3.4201311E−01 | −2.1577693E+00 |
| 6 | 9.8974080E+01 | −1.6189005E−01 | −1.1832307E−01 | 1.4015575E−01 | −7.5126841E−01 |
| 7 | 1.7991247E+02 | −2.3849840E−01 | −1.5622534E−01 | 1.7557751E−01 | −8.2110541E−01 |
| 8 | −1.5735080E+05 | −5.0466197E−01 | −3.6485934E−01 | 3.6376662E−01 | 1.1560900E−01 |
| 9 | −1.6455300E+03 | −3.4957338E−01 | −1.8733023E−01 | 1.6405977E−02 | 2.0081105E−01 |
| 10 | −3.2394182E−01 | −1.2369677E−01 | −2.6645579E−01 | 1.6280252E+00 | −5.3426842E+00 |
| 11 | −2.4413047E+00 | −1.4028162E−01 | 4.7422554E−02 | 6.1082557E−01 | −6.4771422E−01 |
| 12 | −3.3269242E+00 | −5.1190868E−01 | 7.9326158E−01 | −6.6085844E−01 | 3.1774236E−01 |
| 13 | −9.1014541E+00 | −2.8082159E−01 | 3.5797551E−01 | −3.1727793E−01 | 1.8096966E−01 |

| Surface | | | |
|---|---|---|---|
| Number | A12 | A14 | A16 |
| 1 | −3.4030500E−01 | — | — |
| 2 | 1.8155353E−01 | — | — |
| 4 | −1.3467074E−01 | — | — |
| 5 | 4.3971188E+00 | — | — |
| 6 | −2.6173576E−01 | — | — |
| 7 | −5.9598780E−01 | — | — |
| 8 | −1.4605556E+00 | — | — |
| 9 | −6.7301482E−03 | — | — |
| 10 | 8.8958013E+00 | −7.9083378E+00 | 2.4030338E+00 |
| 11 | −1.5086608E−01 | 3.7683914E−01 | −1.1336336E−01 |
| 12 | −1.2077689E−01 | 4.7164771E−02 | −9.9490155E−03 |
| 13 | −6.4451819E−02 | 1.2701466E−02 | −1.0410385E−03 |

TABLE 5
Example 3
f = 2.80, Bf = 0.56, Fno. = 2.10, 2ω = 79.8

| Si | Ri | Di | Ndj | νdj |
|---|---|---|---|---|
| *1 | 1.1305 | 0.5000 | 1.544 | 55.9 |
| *2 | 18.1449 | 0.0602 | | |
| 3 (St) | ∞ | 0.0002 | | |
| *4 | −37.5595 | 0.1703 | 1.650 | 21.4 |
| *5 | 3.0473 | 0.1483 | | |
| *6 | 7.0486 | 0.4478 | 1.544 | 55.9 |
| *7 | −11.2363 | 0.1056 | | |
| *8 | −42.4217 | 0.2079 | 1.650 | 21.4 |
| *9 | −88.2640 | 0.1772 | | |
| *10 | −2.5488 | 0.4426 | 1.544 | 55.9 |
| *11 | −0.8727 | 0.2695 | | |
| *12 | −2.6824 | 0.2488 | 1.544 | 55.9 |
| *13 | 1.0903 | 0.2500 | | |
| *14 | ∞ | 0.2500 | 1.517 | 64.2 |
| *15 | ∞ | 0.1490 | | |
| 16(IMG) | ∞ | | | |

*aspherical surface

TABLE 6
Example 3: Aspherical Surface Data

| Surface | | | | | |
|---|---|---|---|---|---|
| Number | KA | A4 | A6 | A8 | A10 |
| 1 | 4.2254680E−01 | 4.3295455E−02 | 7.4248215E−02 | −1.5805797E−01 | 3.2411961E−01 |
| 2 | −3.0287635E+03 | 9.8453604E−02 | −1.5812328E−01 | 1.6098230E−01 | −2.5116601E−01 |
| 4 | −9.6256487E+03 | 7.1281700E−02 | 7.2167652E−02 | −9.3185587E−02 | 1.7729171E−01 |
| 5 | −4.5718664E+00 | 8.5031972E−02 | 1.8109733E−01 | 3.4488284E−01 | −2.2321927E+00 |
| 6 | 9.1533353E+01 | −1.5813007E−01 | −1.1335027E−01 | 1.3930780E−01 | −7.4355232E−01 |
| 7 | 1.8479423E+02 | −2.5188419E−01 | −1.5891286E−01 | 2.1113975E−01 | −7.7391066E−01 |
| 8 | 3.4361795E+03 | −5.0202552E−01 | −3.7391476E−01 | 3.2178913E−01 | 1.3631240E−01 |
| 9 | 7.9671358E+03 | −3.3974560E−01 | −1.7923508E−01 | 1.6460187E−02 | 1.7071663E−01 |
| 10 | −3.3271758E+00 | −1.1018820E−01 | −2.4949439E−01 | 1.6097987E+00 | −5.3630729E+00 |
| 11 | −2.2240915E+00 | −1.1936631E−01 | 3.0467825E−02 | 6.1170335E−01 | −6.4381988E−01 |
| 12 | −4.2096098E+00 | −5.2209627E−01 | 8.0321620E−01 | −6.5774699E−01 | 3.1785390E−01 |
| 13 | −9.4139077E+00 | −2.7943313E−01 | 3.5820537E−01 | −3.1703607E−01 | 1.8094764E−01 |

| Surface | | | |
|---|---|---|---|
| Number | A12 | A14 | A16 |
| 1 | −3.4030500E−01 | — | — |
| 2 | 1.1216720E−01 | — | — |
| 4 | 3.8644833E−03 | — | — |
| 5 | 4.0258675E+00 | — | — |
| 6 | −2.3460445E−01 | — | — |
| 7 | −5.0168017E−01 | — | — |
| 8 | −1.3372092E+00 | — | — |
| 9 | −7.5564177E−02 | — | — |
| 10 | 8.8743786E+00 | −7.9424582E+00 | 2.4375338E+00 |
| 11 | −1.4828737E−01 | 3.7714015E−01 | −1.1421547E−01 |
| 12 | −1.2115610E−01 | 4.6934540E−02 | −1.0017081E−02 |
| 13 | −6.4438240E−02 | 1.2707250E−02 | −1.0430401E−03 |

TABLE 7
Example 4
f = 2.95, Bf = 0.65, Fno. = 2.10, 2ω = 76.0

| Si | Ri | Di | Ndj | νdj |
|---|---|---|---|---|
| *1 | 1.1647 | 0.4193 | 1.544 | 55.9 |
| *2 | −94.3765 | 0.0600 | | |
| 3 (St) | ∞ | 0.0184 | | |
| *4 | −74.3253 | 0.1701 | 1.650 | 21.4 |
| *5 | 2.6589 | 0.1858 | | |
| *6 | 7.5599 | 0.4941 | 1.544 | 55.9 |
| *7 | −14.2342 | 0.1973 | | |
| *8 | −91.8740 | 0.1894 | 1.650 | 21.4 |
| *9 | 13.6121 | 0.1346 | | |
| *10 | −21.1939 | 0.4634 | 1.544 | 55.9 |
| *11 | −0.9350 | 0.2110 | | |
| *12 | −1.4545 | 0.2049 | 1.544 | 55.9 |
| *13 | 1.3030 | 0.2500 | | |
| *14 | ∞ | 0.2500 | 1.517 | 64.2 |
| *15 | ∞ | 0.2318 | | |
| 16(IMG) | ∞ | | | |

*aspherical surface

TABLE 8
Example 4: Aspherical Surface Data

| Surface | | | | | |
|---|---|---|---|---|---|
| Number | KA | A4 | A6 | A8 | A10 |
| 1 | 4.1787966E−01 | 4.1228993E−02 | 7.7773159E−02 | −2.0238037E−01 | 3.7028596E−01 |
| 2 | 2.5873807E+03 | 7.2474524E−02 | −1.4495583E−01 | 2.2824868E−01 | −2.5643307E−01 |
| 4 | −4.7329939E+04 | 5.4344998E−02 | 9.3445910E−02 | −1.2588762E−01 | 1.6613786E−01 |
| 5 | −4.5488552E+00 | 7.5486781E−02 | 1.0088328E−01 | 6.0621920E−01 | −1.9427702E+00 |
| 6 | 9.1843744E+01 | −1.5586044E−01 | −1.7882831E−01 | 2.8302174E−01 | −3.3463313E−01 |
| 7 | 2.0314215E+02 | −2.0553116E−01 | −1.6421018E−01 | 1.7918093E−01 | −6.2697891E−01 |
| 8 | −6.0296943E+03 | −4.3095784E−01 | −3.6786905E−01 | 2.8558384E−01 | 2.5056850E−01 |
| 9 | −8.3225615E+02 | −3.7839154E−01 | −1.4212987E−01 | 7.4055382E−02 | 1.6045623E−01 |
| 10 | 1.8545934E+02 | −1.2804615E−01 | −2.4911580E−01 | 1.6421312E+00 | −5.4041187E+00 |
| 11 | −3.5193298E+00 | −1.4822784E−01 | 3.2627361E−02 | 5.9231103E−01 | −6.4055591E−01 |
| 12 | −5.8042817E−01 | −5.5674824E−01 | 7.9848524E−01 | −6.1998193E−01 | 3.2136953E−01 |
| 13 | −1.8062540E+01 | −3.0603669E−01 | 3.6143652E−01 | −3.1977567E−01 | 1.8087771E−01 |

| Surface | | | |
|---|---|---|---|
| Number | A12 | A14 | A16 |
| 1 | −3.4030500E−01 | — | — |
| 2 | 1.1722870E−01 | — | — |
| 4 | 1.3845305E−01 | — | — |
| 5 | 2.5892424E+00 | — | — |
| 6 | −5.4213506E−01 | — | — |
| 7 | 1.8331773E−01 | — | — |
| 8 | −8.8577009E−01 | — | — |
| 9 | −1.3529401E−01 | — | — |
| 10 | 8.9390116E+00 | −7.7916813E+00 | 2.4899022E+00 |
| 11 | −1.4733114E−01 | 3.7561489E−01 | −1.1136115E−01 |
| 12 | −1.2377807E−01 | 4.2948664E−02 | −1.1485902E−02 |
| 13 | −6.3815547E−02 | 1.2770001E−02 | −1.1206632E−03 |

TABLE 9
Example 5
f = 2.96, Bf = 0.64, Fno. = 2.10, 2ω = 76.2

| Si | Ri | Di | Ndj | νdj |
|---|---|---|---|---|
| *1 | 1.1776 | 0.4911 | 1.544 | 55.9 |
| *2 | −38.3735 | 0.0602 | | |
| 3 (St) | ∞ | 0.0167 | | |
| *4 | −26.5808 | 0.1715 | 1.650 | 21.4 |
| *5 | 2.6712 | 0.1560 | | |
| *6 | 6.9686 | 0.4998 | 1.544 | 55.9 |
| *7 | −14.5242 | 0.1687 | | |
| *8 | 18.6389 | 0.1990 | 1.650 | 21.4 |
| *9 | 10.3889 | 0.1755 | | |
| *10 | −16.5844 | 0.4458 | 1.544 | 55.9 |
| *11 | −0.9342 | 0.1719 | | |
| *12 | −1.4434 | 0.2174 | 1.544 | 55.9 |
| *13 | 1.2951 | 0.2500 | | |
| *14 | ∞ | 0.2500 | 1.517 | 64.2 |
| *15 | ∞ | 0.2273 | | |
| 16(IMG) | ∞ | | | |

*aspherical surface

TABLE 10
Example 5: Aspherical Surface Data

| Surface | | | | | |
|---|---|---|---|---|---|
| Number | KA | A4 | A6 | A8 | A10 |
| 1 | 2.7106269E−01 | 4.3278958E−02 | 6.9616701E−02 | −2.0602201E−01 | 3.5641598E−01 |
| 2 | 2.2685747E+03 | 7.0872134E−02 | −1.4880920E−01 | 2.1357045E−01 | −2.6029799E−01 |
| 4 | −7.9060590E+03 | 5.1680550E−02 | 9.4591877E−02 | −1.1466673E−01 | 1.8694309E−01 |
| 5 | −2.9005639E+00 | 7.8368393E−02 | 7.3547378E−02 | 5.9804394E−01 | −1.8913037E+00 |
| 6 | 9.5331722E+01 | −1.5025263E−01 | −1.9595995E−01 | 2.4639103E−01 | −4.0048240E−01 |
| 7 | 2.2774719E+02 | −2.0898924E−01 | −1.5991574E−01 | 1.8829947E−01 | −6.2533512E−01 |
| 8 | −4.0033593E+03 | −4.2942477E−01 | −3.6611808E−01 | 2.8181022E−01 | 2.3683923E−01 |
| 9 | −8.5570441E+02 | −3.7924231E−01 | −1.4384188E−01 | 7.2225082E−02 | 1.5975512E−01 |
| 10 | 1.8664470E+02 | −1.2861732E−01 | −2.4932432E−01 | 1.6453475E+00 | −5.4001204E+00 |
| 11 | −3.7650057E+00 | −1.4786200E−01 | 3.2392088E−02 | 5.9090615E−01 | −6.4381779E−01 |
| 12 | −5.6183029E−01 | −5.5731038E−01 | 7.9345696E−01 | −6.2869218E−01 | 3.1513830E−01 |
| 13 | −1.8087680E+01 | −3.0347166E−01 | 3.6190105E−01 | −3.2052998E−01 | 1.7931501E−01 |

| Surface | | | |
|---|---|---|---|
| Number | A12 | A14 | A16 |
| 1 | −3.4030500E−01 | — | — |
| 2 | 1.5050968E−01 | — | — |
| 4 | 1.5555916E−01 | — | — |
| 5 | 2.7849813E+00 | — | — |
| 6 | −6.3189493E−01 | — | — |
| 7 | 1.1753458E−01 | — | — |
| 8 | −9.2781170E−01 | — | — |
| 9 | −1.3904832E−01 | — | — |
| 10 | 8.9310915E+00 | −7.8290495E+00 | 2.4914157E+00 |
| 11 | −1.5175576E−01 | 3.7417025E−01 | −1.0922733E−01 |
| 12 | −1.0947030E−01 | 4.1907083E−02 | −1.5425608E−02 |
| 13 | −6.3614599E−02 | 1.3122053E−02 | −1.2183883E−03 |

TABLE 11
Example 6
f = 3.00, Bf = 0.68, Fno. = 2.10, 2ω = 74.6

| Si | Ri | Di | Ndj | νdj |
|---|---|---|---|---|
| *1 | 1.1524 | 0.4644 | 1.544 | 55.9 |
| *2 | −77.8679 | 0.0602 | | |
| 3 (St) | ∞ | 0.0283 | | |
| *4 | −42.9203 | 0.1992 | 1.650 | 21.4 |
| *5 | 2.4690 | 0.1675 | | |
| *6 | 7.0915 | 0.4142 | 1.544 | 55.9 |
| *7 | −12.5427 | 0.1746 | | |
| *8 | −39.9314 | 0.1864 | 1.650 | 21.4 |
| *9 | −98.7429 | 0.2238 | | |
| *10 | −17.2000 | 0.4696 | 1.544 | 55.9 |
| *11 | −0.9323 | 0.1113 | | |
| *12 | −1.4773 | 0.2471 | 1.544 | 55.9 |
| *13 | 1.3253 | 0.2500 | | |
| *14 | ∞ | 0.2500 | 1.517 | 64.2 |
| *15 | ∞ | 0.2642 | | |
| 16(IMG) | ∞ | | | |

*aspherical surface

TABLE 12
Example 6: Aspherical Surface Data

| Surface | | | | | |
|---|---|---|---|---|---|
| Number | KA | A4 | A6 | A8 | A10 |
| 1 | 3.7984422E−01 | 4.0135291E−02 | 7.8880271E−02 | −2.0333543E−01 | 3.6463578E−01 |
| 2 | 5.2885038E+03 | 6.8728788E−02 | −1.4644796E−01 | 2.2340247E−01 | −2.6477666E−01 |
| 4 | −2.8834219E+04 | 4.7124168E−02 | 9.0191189E−02 | −1.2220188E−01 | 1.6197938E−01 |
| 5 | −2.6143138E+00 | 8.5745144E−02 | 1.0957607E−01 | 5.6441593E−01 | −1.9613212E+00 |
| 6 | 9.0801555E+01 | −1.5094623E−01 | −1.9499664E−01 | 2.4853280E−01 | −3.5238239E−01 |
| 7 | 2.1425862E+02 | −2.0765283E−01 | −1.5971272E−01 | 1.9692839E−01 | −6.1080911E−01 |
| 8 | −1.3633132E+04 | −4.2990320E−01 | −3.6798773E−01 | 2.8089289E−01 | 2.3927108E−01 |
| 9 | −4.3954281E+03 | −3.7876590E−01 | −1.4234474E−01 | 7.4841450E−02 | 1.6104078E−01 |
| 10 | 1.9993152E+02 | −1.2835071E−01 | −2.5105789E−01 | 1.6366818E+00 | −5.4143764E+00 |
| 11 | −3.6345293E+00 | −1.4795197E−01 | 3.2577616E−02 | 5.9285596E−01 | −6.3817209E−01 |
| 12 | −5.6249227E−01 | −5.5817407E−01 | 7.9995742E−01 | −6.1898967E−01 | 3.1764523E−01 |
| 13 | −1.6785061E+01 | −3.0509670E−01 | 3.5748659E−01 | −3.2434054E−01 | 1.8118647E−01 |

| Surface | | | |
|---|---|---|---|
| Number | A12 | A14 | A16 |
| 1 | −3.4030500E−01 | — | — |
| 2 | 1.0754249E−01 | — | — |
| 4 | 1.0318227E−01 | — | — |
| 5 | 2.8885817E+00 | — | — |
| 6 | −5.5285476E−01 | — | — |
| 7 | 1.1729685E−01 | — | — |
| 8 | −8.8187771E−01 | — | — |
| 9 | −1.4153957E−01 | — | — |
| 10 | 8.9346565E+00 | −7.7656943E+00 | 2.3811893E+00 |
| 11 | −1.4594349E−01 | 3.5741240E−01 | −1.0394929E−01 |
| 12 | −1.2718737E−01 | 5.6715993E−02 | −1.9784615E−02 |
| 13 | −6.3944334E−02 | 1.3604759E−02 | −1.3622362E−03 |

TABLE 13
Values Related to Conditional Formulae

| Formula | Condition | Example 1 | Example 2 | Example 3 | Example 4 | Example 5 | Example 6 |
|---|---|---|---|---|---|---|---|
| 1 | f3/f1 | 3.80 | 3.70 | 3.66 | 4.32 | 4.14 | 4.01 |
| 2 | f1/f6 | −1.56 | −1.55 | −1.58 | −1.72 | −1.73 | −1.68 |
| 3 | f34/f | 3.63 | 4.23 | 3.06 | 5.91 | 3.79 | 3.03 |
| 4 | (L1r + L1f)/(L1r − L1f) | 1.13 | 1.09 | 1.13 | 0.98 | 0.94 | 0.97 |
| 5 | (L5r + L5f)/(L5r − L5f) | −1.99 | −1.81 | −2.04 | −1.09 | −1.12 | −1.11 |
| 6 | f · tanω/L6r | 2.1 | 2.1 | 2.1 | 1.8 | 1.8 | 1.7 |

Note that the above paraxial radii of curvature, the distances among surfaces, the refractive indices, and the Abbe's numbers were obtained by measurements performed by specialists in the field of optical measurement, according to the methods described below.

The paraxial radii of curvature were obtained by measuring the lenses using an ultra high precision three dimensional measurement device UA3P (by Panasonic Factory Solutions K. K.) by the following procedures. A paraxial radius of curvature Rₘ (m is a natural number) and a conical coefficient Kₘ are preliminarily set and input into UA3P, and an nth order aspherical surface coefficient An of an aspherical shape formula is calculated from the input paraxial radius of curvature Rₘ and conical coefficient Kₘ and the measured data, using a fitting function of UA3P. C=1/Rₘ and KA=Kₘ−1 are considered in the aforementioned aspherical surface shape formula (A). Depths Z of an aspherical surface in the direction of the optical axis corresponding to heights h from the optical axis are calculated from Rₘ, Kₘ, An, and the aspherical surface shape formula. The difference between the calculated depths Z and actually measured depth values Z′ are obtained for each height h from the optical axis. Whether the difference is within a predetermined range is judged. In the case that the difference is within the predetermined range, Rₘ is designated as the paraxial radius of curvature. On the other hand, in the case that the difference is outside the predetermined range, the value of at least one of Rₘ and Kₘ is changed, set as Rₘ₊₁ and Kₘ₊₁, and input to UA3P. The processes described above are performed, and judgment regarding whether the difference between the calculated depths Z and actually measured depth values Z′ for each height h from the optical axis is within a predetermined range is judged. These procedures are repeated until the difference between the calculated depths Z and actually measured depth values Z′ for each height h from the optical axis is within a predetermined range. Note that here, the predetermined range is set to be 200 nm or less. In addition, a range from 0 to ⅕ the maximum lens outer diameter is set as the range of h.

The distances among surfaces are obtained by measurements using OptiSurf (by Trioptics), which is an apparatus for measuring the central thicknesses and distances between surfaces of paired lenses.

The refractive indices are obtained by performing measurements in a state in which the temperature of a measurement target is 25° C., using KPR-2000 (by K. K. Shimadzu), which is a precision refractometer. The refractive index measured with respect to the d line (wavelength: 587.6 nm) is designated as Nd. Similarly, the refractive index measured with respect to the e line (wavelength: 546.1 nm) is designated as Ne, the refractive index measured with respect to the F line (wavelength: 486.1 nm) is designated as NF, the refractive index measured with respect to the C line (wavelength: 656.3 nm) is designated as NC, and the refractive index measured with respect to the g line (wavelength: 435.8 nm) is designated as Ng. The Abbe's number vd with respect to the d line is obtained by calculations, substituting the values of Nd, NF, and NC obtained by the above measurements into the formula below.

vd=(Nd−1)/(NF−NC)

What is claimed is:

1. An imaging lens consisting essentially of six lenses, including:
a first lens having a positive refractive power and a convex surface toward the object side;
a second lens having a negative refractive power and a concave surface toward the object side;
a third lens having a positive refractive power;
a fourth lens having a negative refractive power;
a fifth lens having a positive refractive power; and
a sixth lens having a negative refractive power, provided in this order from the object side;
the imaging lens satisfying the following conditional formula:
2.4<f3/f1<4.6 (1)
wherein f1 is the focal length of the first lens, and f3 is the focal length of the third lens.

2. An imaging lens as defined in claim 1, wherein:
the fifth lens has a concave surface toward the object side.

3. An imaging lens as defined in claim 1, wherein:
the sixth lens has a concave surface toward the object side.

4. An imaging lens consisting essentially of six lenses, including:
a first lens having a positive refractive power and a convex surface toward the object side;
a second lens of a biconcave shape;
a third lens having a positive refractive power;
a fourth lens having a negative refractive power;
a fifth lens having a positive refractive power and a concave surface toward the object side; and
a sixth lens having a negative refractive power and a concave surface toward the object side, provided in this order from the object side.

5. An imaging lens as defined in claim 4 that further satisfies the conditional formula below:
2.4<f3/f1<4.6 (1)
wherein f1 is the focal length of the first lens, and f3 is the focal length of the third lens.

6. An imaging lens as defined in claim 1 that further satisfies the conditional formula below:
−2.1<f1/f6<−1.54 (2)
wherein f1 is the focal length of the first lens, and f6 is the focal length of the sixth lens.

7. An imaging lens as defined in claim 1 that further satisfies the conditional formula below:
2.9<f34/f<8 (3)
wherein f34 is the combined focal length of the third lens and the fourth lens, and f is the focal length of the entire system.

8. An imaging lens as defined in claim 1 that further satisfies the conditional formula below:
0.85<(L1r+L1f)/(L1r−L1f)<1.16 (4)
wherein L1f is the paraxial radius of curvature of the surface of the first lens toward the object side, and L1r is the paraxial radius of curvature of the surface of the first lens toward the image side.

9. An imaging lens as defined in claim 1 that further satisfies the conditional formula below:
−2.4<(L5r+L5f)/(L5r−L5f)<−0.9 (5)
wherein L5f is the paraxial radius of curvature of the surface of the fifth lens toward the object side, and L5r is the paraxial radius of curvature of the surface of the fifth lens toward the image side.

10. An imaging lens as defined in claim 1 that further satisfies the conditional formula below:
0.5<f·tan ω/L6r<20 (6)
wherein f is the focal length of the entire system, ω is half the maximum angle of view when focused on an object at infinity, and L6r is the paraxial radius of curvature of the surface of the sixth lens toward the image side.

11. An imaging lens as defined in claim 1, further comprising:
an aperture stop positioned at the object side of the surface of the second lens toward the object side.

12. An imaging lens as defined in claim 1 that further satisfies the conditional formula below:
2.8<f3/f1<4.5 (1-1)
wherein f1 is the focal length of the first lens, and f3 is the focal length of the third lens.

13. An imaging lens as defined in claim 1 that further satisfies the conditional formula below:
−2<f1/f6<−1.55 (2-1)
wherein f1 is the focal length of the first lens, and f6 is the focal length of the sixth lens.

14. An imaging lens as defined in claim 1 that further satisfies the conditional formula below:
2.95<f34/f<7.1 (3-1)
wherein f34 is the combined focal length of the third lens and the fourth lens, and f is the focal length of the entire system.

15. An imaging lens as defined in claim 1 that further satisfies the conditional formula below:
0.87<(L1r+L1f)/(L1r−L1f)<1.15 (4-1)
wherein L1f is the paraxial radius of curvature of the surface of the first lens toward the object side, and L1r is the paraxial radius of curvature of the surface of the first lens toward the image side.

16. An imaging lens as defined in claim 1 that further satisfies the conditional formula below:
−2.2<(L5r+L5f)/(L5r−L5f)<−0.95 (5-1)
wherein L5f is the paraxial radius of curvature of the surface of the fifth lens toward the object side, and L5r is the paraxial radius of curvature of the surface of the fifth lens toward the image side.

17. An imaging lens as defined in claim 1 that further satisfies the conditional formula below:
3<f3/f1<4.4 (1-2)
wherein f1 is the focal length of the first lens, and f3 is the focal length of the third lens.

18. An imaging lens as defined in claim 1 that further satisfies the conditional formula below:
3<f34/f<6.5 (3-2)
wherein f34 is the combined focal length of the third lens and the fourth lens, and f is the focal length of the entire system.

19. An imaging lens as defined in claim 1 that further satisfies the conditional formula below:
−2.1<(L5r+L5f)/(L5r−L5f)<−1 (5-2)
wherein L5f is the paraxial radius of curvature of the surface of the fifth lens toward the object side, and L5r is the paraxial radius of curvature of the surface of the fifth lens toward the image side.

20. An imaging apparatus equipped with an imaging lens as defined in claim 1.
